(19) United States
(12) Patent Application Publication
(10) Pub. No.: US 2010/0094495 A1
(43) Pub. Date: Apr. 15, 2010

(54) PITCHING CONTROL DEVICE OF MOTOR VEHICLE AND CONTROL METHOD

(75) Inventors: Hiroshi Fujimoto, Yokohama-shi (JP); Shinsuke Satoh, Yokohama-shi (JP)

Correspondence Address: VENABLE LLP, P.O. BOX 34385, WASHINGTON, DC, 20043-9998, US

(73) Assignee: YOKOHAMA NATIONAL UNIVERSITY, Yokohama-shi, Kanagawa (JP)

(21) Appl. No.: 12/530,115

(22) PCT Filed: Mar. 4, 2008
(86) PCT No.: PCT/JP2008/053877

§ 371 Date: Sep. 4, 2009

(30) Foreign Application Priority Data
Mar. 5, 2007 (JP) 2007-054614
Aug. 17, 2007 (JP) 2007-213184

(51) Int. Cl. B60L 15/20

(52) U.S. Cl. 701/22

(57) ABSTRACT

The present invention has an object to provide a pitching control device of a vehicle that controls a pitching motion by controlling a torque of its driving wheels and a control method. In the motor vehicle that drives the driving wheels by the torque of a motor, a moment about the center of gravity of the motor vehicle is found from variations of loads applied to the wheels of the motor vehicle at the time of acceleration that include loads applied to th wheels of the motor vehicle at the time of standstill and an anti-dive force working on front wheels of the motor vehicle and an anti-lift force working on rear wheels of the motor vehicle at the time of braking by a brake. A pitch angle of the motor is computed from this moment. The motor torque of the motor is computed based on the computed pitch angle.

### TECHNICAL FIELD

The present invention relates to a pitching control device of a motor vehicle and a control method of it, and more specifically, to a pitching control device of a motor vehicle for controlling pitching by a control of a torque of a motor and a control method.

### BACKGROUND ART

In energy and environmental issues, the electric vehicle is considerably superior to the internal combustion engine vehicle, and attracts attention. However, the electric vehicle that uses a motor as a driving force has large superiority also in the following points: responsiveness from a torque command value to generated torque is excellent, which is a characteristic of motors; the generated torque can be grasped accurately by measuring a motor current; and the motor can be disposed in a distributed manner to respective wheels of tire because the motor is compact (refer to Non-patent Documents 1, 2). An attention is paid to characteristics of this motor, and researches of vehicle control unique to the electric vehicle are being done (refer to Non-patent Document 3).

Vehicle motions include a pitching motion that affects riding comfort largely. The pitching is a motion about the center of gravity of a car body that arises from occurrence of a longitudinal acceleration when the driving force and a braking force are applied to a motor vehicle while running on a straight line and simultaneous addition of the moment about the center of gravity axis (y-axis) of the car body. The present invention performs a control of the pitching motion.

As pitching control methods having been proposed up to now,

there is one method of performing a feedforward control whereby a predetermined correction torque is added to a measured pitching quantity in a direction of controlling the pitching quantity and the direction of the correction torque is changed each time its polarity variations (refer to Patent Documents 1, 2). There is also a pitching control method, which is similarly a feedforward control, of using a detailed on-spring vibration model and performing state feedback to the model (Patent Document 3)

However, hitherto there is no model of precisely analyzing the pitching motion of a vehicle, and the pitching control device using a fast response of the motor that is a characteristic of the electric vehicle dose not exist, either. Moreover, in practice, the acceleration aₓₘ by a motor torque depends not only on a torque command value but also on a road surface state. Therefore, an error of aₓₘ is large, and there was a problem that it was difficult to perform the pitching control with high accuracy. Furthermore, since a hall sensor of the motor has a low resolution, when obtaining the brake torque and a nominal acceleration, the wheel angular velocity w with low accuracy is differentiated for it.

[Formula 1]

ω^{·}

(ωdot) There is a problem that a noise rides on the wheel angular velocity largely, which reduces accuracy of the pitching control.

The present invention was made in view of such a problem, and an object thereof is to provide the pitching control device of a motor vehicle for controlling the pitching motion by controlling the torque of driving wheels, and a control method of it. Moreover, the object is to provide a high-accuracy pitching control device by means of torque control of the motor based on a brake torque estimation method considering the slip ratio, and a control method. Moreover, the object is to provide the high-accuracy pitching control device considering a road surface situation without using a wheel angular acceleration, and a control method.

Patent Document 1: Japanese Patent Laid-Open No. 62-12305

Patent Document 2: Japanese Patent Laid-Open No. 2007-186130

Patent Documents 3: Japanese Patent Laid-Open No. 2006-60936

Non-patent Document 1: S. Sasakai and Y. Hori: “Advanced Vehicle Motion Control of Electric Vehicle,” Ph D. Thesis, The University of Tokyo (1999) (in Japanese)

Non-patent Document 2: T. Koike and Y. Hori, “Advanced Braking System based on High Speed Response of Electric Motor,” IIC-06-2 (2006)

Non-patent Document 3: H. Fujimoto, K. Fujii, and N. Takahashi: “Road Condition Estimation and Motion Control of Electric Vehicle with In-wheel Motors,” JSAE Annual Congress, pp. 25-28 (2007)

Non-patent Document 4: “Movement Dynamics of Motor Vehicle,” Basic Seminar (2006)

Non-patent Document 5: Edited by Incorporated Company, Japan Society of Mechanical Engineers, “Dynamics and Control of Vehicle System,” published by Yokendo, Co. Ltd.

Non-patent Document 6: M. Kamachi and K. Walters: “A Research of Direct Yaw-Moment Control on Slippery Road for M-Wheel Motor Vehicle,” EVS-22 Yokohama, JAPAN, Oct. 23-28, pp. 2122-2133 (2006)

Non-patent Document 7: Takaaki Uno, “Vehicle Kinematic Performance and Chassis Mechanism,” Published by Grand Prix Press

Non-patent Document 8: K. Fujii and H. Fujimoto; “Slip Ratio Control based on Wheel Control without Detection of Vehicle Speed for Electric vehicle,” VT-07-05, pp. 27-32 (2007)

Non-patent Document 9: Edited by Kayaba Industry Co., Ltd., “Suspensions of Vehicle,” Published by SANKAIDO PUBLISHING Co., Ltd.

Non-patent Document 10: Toru Suzuki and Hiroshi Fujimoto, “Proposal of Slip Ratio Estimation Method without Detection of Vehicle Speed for Electric Vehicle on Deceleration,” IEE of Japan Technical Meeting Record, 2007, pp. 77-82

### DISCLOSURE OF THE INVENTION

The present invention is a pitching control device, in the motor vehicle that drives its driving shaft with the torque of the motor, characterized by comprising: pitch angle computing means for computing a pitch angle of the motor from a moment about the center of gravity of the motor vehicle based on loads applied to wheels of the motor vehicle at the time of standstill, loads applied to the wheels of the motor vehicle at the time of acceleration and deceleration by the motor, and variations of loads applied to the wheels of the motor vehicle by an anti-dive force working on front wheels of the motor vehicle and an anti-lift force working on rear wheels of the motor vehicle at the time of braking by a brake; motor torque computing means for computing a motor torque of the motor based on the pitch angle; and motor control means for controlling the motor using the motor torque.

Moreover, one mode of the present invention is characterized by further comprising feedback control means for compensating a difference between a pitch rate derived from the pitch angle computed by the pitch angle computing means and the pitch rate of the motor.

Moreover, one mode of the present invention is characterized by further comprising brake torque estimating means for estimating a brake torque, wherein the pitch angle computing means computes the acceleration based on the brake torque.

Moreover, one mode of the present invention is characterized in that the brake torque estimating means performs estimation considering a slip ratio.

Moreover, one mode of the present invention is characterized in that the brake torque estimating means performs estimation that further considers a time variation of the slip ratio.

Moreover, one mode of the present invention is further equipped with an acceleration sensor for measuring the acceleration of the car body of the motor vehicle, and is characterized in that the brake torque estimating means performs estimation using the acceleration.

Moreover, one mode of the present invention is the pitching control device, in a motor vehicle that drives its driving wheels by the torque of the motor, comprising: the acceleration sensor for measuring an acceleration of a car body of the motor vehicle; state feedback control means that estimates state variables including the pitch angle through a state observer using a model for computing the pitch angle from a moment about a point of the center of gravity of the motor vehicle based on the acceleration, loads applied to the wheels of the motor vehicle at the time of standstill, loads applied to the wheels of the motor vehicle at the time of acceleration and deceleration by the motor, and variations of loads applied to the wheels of the motor vehicle by the anti-dive force working on the front wheels of the motor vehicle and the anti-lift force working on the rear wheels of the motor vehicle at the time of braking by a brake and uses the estimated value of the state variables; wheel speed control means for computing the motor torque of the motor based on the slip ratio computed by the state feedback control means; and the motor control means for controlling the motor using the motor torque.

Moreover, one mode of the present invention is characterized in that the wheel speed control means determines a control gain by a pole assignment technique considering only moments of inertia of the wheels and the control gain is adjusted so that the pole may become constant to the moments of inertia of the wheels at the time of acceleration and deceleration.

Moreover, one mode of the present invention is characterized in that the pitch computing means computes the pitch angle based on Formula (A),

$$\begin{matrix}[ Formula 2 ] & \\ θ = \frac{- 2 mh - m ( β {l}_{f} tan {φ}_{f} + ( 1 - β ) {l}_{r} tan {φ}_{r} )}{{Is}^{2} + Cs + K} {a}_{x} & ( A )\end{matrix}$$

(where m: car body weight, h: height from the ground plane to the center of gravity, l_{f}: distance between the center of gravity and a front wheel shaft, lᵣ: distance between the center of gravity and a rear wheel shaft, I: moment of inertia about a y-axis of the car body, C: damper coefficient, K: spring constant, β: braking force distributed to the front wheels, φ_{f}: anti-dive force direction, and φᵣ: anti-lift force direction).

Moreover, another mode of the present invention is a pitching control method, in the motor vehicle that drives its driving wheels by the torque of the motor, comprising: a pitch angle computation step of computing the pitch angle of the driving shaft from a moment about the center of gravity of the motor vehicle based on loads applied to the wheels of the motor vehicle at the time of standstill, loads applied to the wheels of the motor vehicle at the time of acceleration and deceleration, and variations of loads applied to the wheels of the motor vehicle by the anti-dive force working on the front wheels of the motor vehicle and the anti-lift force working on the rear wheels of the motor vehicle at the time of braking by a brake, a motor torque computation step of computing a motor torque of the motor based on the pitch angle; and a motor control step of controlling the motor using the motor torque.

Moreover, one mode of the present invention is characterized by further comprising a feedback control step of compensating a difference between the pitch rate derived from the pitch angle computed at the pitch angle computation step and the pitch rate of the motor.

Moreover, one mode of the present invention is characterized by further comprising a brake torque estimation step of estimating the brake torque, wherein the pitch angle computing means computes the acceleration based on the brake torque.

Moreover, one mode of the present invention is characterized in that the brake torque estimation step performs estimation considering the slip ratio.

Moreover, one mode of the present invention is characterized in that the brake torque estimation step performs estimation that further considers the time variation of the slip ratio.

Moreover, one mode of the present invention is characterized by further comprising an acceleration measurement step of measuring the acceleration of the car body of the motor vehicle with the acceleration sensor, wherein the brake torque estimation step performs estimation using the acceleration.

Moreover, one mode of the present invention is a pitching control method, in a vehicle that drives its driving wheels by the torque of the motor, comprising: the acceleration measurement step of measuring the acceleration of the car body of the motor vehicle with the acceleration sensor; a state feedback control step of estimating variables including the pitch angle through a state observer using a model for computing the pitch angle from a moment about a point of the center of gravity of the motor vehicle based on the acceleration, loads applied to the wheels of the motor vehicle at the time of standstill, loads applied to the wheels of the motor vehicle at the time of acceleration and deceleration by the motor, and variations of loads applied to the wheels of the motor vehicle by the anti-dive force working on the front wheels of the motor vehicle and the anti-lift force working on the rear wheels of the motor vehicle at the time of braking by a brake, and using the estimated values of the state variables; a wheel speed control step of computing the motor torque of the motor based on the slip ratio computed by the state feedback control means; and a motor control step of controlling the motor using the motor torque.

Moreover, one mode of the present invention is characterized in that the wheel speed control step determines a control gain by the pole assignment technique considering only the moments of inertia of the wheels and the control gain is adjusted so that the pole may become constant to the moments of inertia of the wheels at the time of acceleration and deceleration.

Moreover, one mode of the present invention is characterized in that the pitch angle computation step computes the pitch angle based on Formula (A),

$$\begin{matrix}[ Formula 3 ] & \\ θ = \frac{- 2 mh - m ( β {l}_{f} tan {φ}_{f} + ( 1 - β ) {l}_{r} tan {φ}_{r} )}{{Is}^{2} + Cs + K} {a}_{x} & ( A )\end{matrix}$$

(where m: car body weight, h: height from the ground plane to the center of gravity, l_{f}: distance between the center of gravity and the front wheel shaft, lᵣ: distance between the center of gravity and the rear wheel shaft, I: moment of inertia about the y-axis of the car body, C: damper coefficient, K: spring constant, β: braking force distributed to the front wheels, φ_{f}: angle between the ground plane and the anti-dive force direction, and φᵣ: angle between the ground plane and the anti-lift force direction).

According to the present invention, it is possible to control the pitching motion by controlling the torque of the driving wheels. Moreover, in the motor vehicle that uses the motor as power, it becomes possible to perform a high-accuracy pitching control by a torque control of the motor based on a brake torque estimation method considering the slip ratio. Moreover, it becomes possible to perform the high-accuracy pitching control considering a road surface situation without using a wheel angular acceleration.

### BRIEF DESCRIPTION OF THE DRAWINGS

FIG. 1 is a diagram showing 1 degree-of-freedom model of a suspension;

FIG. 2 is a diagram showing a half car model with front-rear two wheels;

FIG. 3 is a diagram showing loads of wheels under steady motion in a four-wheel vehicle;

FIG. 4 is a diagram showing a geometry in the case of in-wheel type driving;

FIG. 5 is a diagram showing a geometry in the case of drive shaft driving;

FIG. 6 is a diagram showing a pitching effect in the in-wheel type driving and in the drive shaft driving;

FIG. 7 is a diagram showing a geometry of anti-dive and anti-lift at the time of braking;

FIG. 8A is a diagram showing an acceleration obtained by an experiment;

FIG. 8B is a diagram showing a pitch rate obtained by the experiment;

FIG. 9 is a diagram showing experimental data of the pitch rate and an identification result of model output data;

FIG. 10 is a block diagram of a 2-degree-of-freedom control of a pitching control device according to a first embodiment of the present invention;

FIG. 11A is a diagram showing a pitch angle in a simulation 1;

FIG. 11B is a diagram showing the pitch rate in the simulation 1;

FIG. 11C is a diagram showing a car body speed in the simulation 1;

FIG. 11D is a diagram showing a braking distance in the simulation 1;

FIG. 12A is a diagram showing the pitch angle in a simulation 2;

FIG. 12B is a diagram showing the pitch rate in the simulation 2;

FIG. 12C is a diagram showing the car body speed in the simulation 2;

FIG. 12D is a diagram showing the braking distance in the simulation 2;

FIG. 13A is a diagram showing the pitch angle in an experiment 1;

FIG. 13B is a diagram showing the pitch rate in the experiment 1;

FIG. 13C is a diagram showing a car body acceleration in the experiment 1;

FIG. 13D is a diagram showing a torque in the case with a control in the experiment 1;

FIG. 14A is a diagram showing the pitch angle in an experiment 2;

FIG. 14B is a diagram showing the pitch rate in the experiment 2;

FIG. 14C is a diagram showing the car body acceleration in the experiment 2;

FIG. 14D is a diagram showing the torque in the case with the control in the experiment 2;

FIG. 15 is a diagram showing the output pitch rates of P(s) and Pₙ(s) in the experiment 1;

FIG. 16 is a diagram showing the output pitch rates of P(s) and Pₙ(s) in the experiment 2;

FIG. 17 is a diagram showing a result of comparing the pitch rate of the experimental result and the output pitch rate when inputting the acceleration at that time into the identified model;

FIG. 18 is a block diagram showing a longitudinal acceleration estimator for estimating a longitudinal acceleration from the torque and a wheel angular acceleration;

FIG. 19 is a block diagram showing a brake torque estimator considering a slip ratio;

FIG. 20 is a block diagram showing the brake torque estimator using an acceleration sensor;

FIG. 21 is a block diagram showing a control system of a 2-degree-of-freedom control system of the pitching control device according to a second embodiment of the present invention;

FIG. 22A is a diagram showing the pitch angles in the case with a pitching control according to the second embodiment of the present invention and in the case without the control;

FIG. 22B is a diagram showing the pitch rate in the case with the pitching control according to the second embodiment of the present invention and in the case without the control;

FIG. 23A is a diagram showing a brake torque estimated value in the case of considering the slip ratio;

FIG. 23B is a diagram showing an estimated value at the time of using the acceleration sensor;

FIG. 24A is a diagram showing the pitch rates in case with the control considering the slip ratio according to one embodiment of the present invention and in the case without the control;

FIG. 24B is a diagram showing the pitch rates in the case with the control using the acceleration sensor according to the one embodiment of the present invention and in the case without the control;

FIG. 24C is a diagram showing the torque that is a control input in the case with the control of FIG. 24A;

FIG. 25 is a diagram showing the brake torque estimated value in the case of considering the slip ratio;

FIG. 26 shows the output pitch rates of an actual plant P(s) and a nominal plant Pₙ(s);

FIG. 27 a diagram showing the brake torque estimated value using the acceleration sensor and the brake torque estimated value in the case of considering the slip ratio;

FIG. 28 is a block diagram for performing brake torque estimation considering a variation of the slip ratio λdot;

FIG. 29 is a diagram showing experimental results at the time of performing the estimation assuming λdot≠0 and at the time of performing the estimation assuming λdot=0;

FIG. 30A is a diagram that is a simulation result on the high μ road in the case of giving a brake torque of 750 Nm, showing the brake torque estimated value considering λdot;

FIG. 30B is a diagram that is a simulation result on the high μ road in the case of giving a brake torque of 750 Nm, showing a wheel speed and the car body speed at the time of FIG. 30A;

FIG. 30C is a diagram that is a simulation result on the high μ road in the case of giving a brake torque of 750 Nm, showing λdot at the time of FIG. 30A;

FIG. 30D is a diagram that is a simulation result on the high μ road in the case of giving a brake torque of 750 Nm, showing the brake torque in the case of assuming λdot=0;

FIG. 31A is a diagram that is a simulation result on the high μ road in the case of giving a brake torque of 500 Nm, showing the brake torque estimated value considering λdot;

FIG. 31B is a diagram that is a simulation result on the high μ road in the case of giving a brake torque of 500 Nm, showing the wheel speed and the car body speed at the time of FIG. 31A;

FIG. 31C is a diagram that is a simulation result on the high μ road in the case of giving a brake torque of 500 Nm, showing λdot at the time of FIG. 31A;

FIG. 31D is a diagram that is a simulation result on the high μ road in the case of giving a brake torque of 500 Nm, showing the brake torque estimated value in the case of assuming λdot=0;

FIG. 32A is a diagram that is a simulation result on the high μ road at the time of giving a brake torque of 750 Nm that produces gradual rise and fall, showing the brake torque estimated value in the case of considering λdot;

FIG. 32B is a diagram that is a simulation result on the high μ road at the time of giving a brake torque of 750 Nm that produces gradual rise and fall, showing the wheel speed and the car body speed at the time of FIG. 32A;

FIG. 32C is a diagram that is a simulation result on the high μ road at the time of giving a brake torque of 750 Nm that produces gradual rise and fall, showing λdot at the time of FIG. 32A;

FIG. 32D is a diagram that is a simulation result on the high μ road at the time of giving a brake torque of 750 Nm that produces gradual rise and fall, showing the brake torque estimated value in the case of assuming λdot=0;

FIG. 33 is a block diagram of a vehicle model that is used in the pitching control device according to the third embodiment of the present invention;

FIG. 34 is a block diagram showing a control system of the pitching control device according to the third embodiment of the present invention;

FIG. 35 is a block diagram that shows a wheel speed control of the pitching control device according to the third embodiment of the present invention;

FIG. 36A is a diagram that is a simulation result when assuming that the control object P(s) is equivalent to the identified model Pₙ(s), showing the pitch rate;

FIG. 36B shows a diagram that is a simulation result when assuming that the control object P(s) is equivalent to the identified model Pₙ(s), showing the pitch angle;

FIG. 36C is a diagram that is a simulation result when assuming that the control object P(s) is equivalent to the identified model Pₙ(s), showing the acceleration;

FIG. 36D is a diagram that is a simulation result when assuming that the control object P(s) is equivalent to the identified model Pₙ(s), showing the slip ratio;

FIG. 36E is a diagram that is a simulation result when assuming that the control object P(s) is equivalent to the identified model Pₙ(s), showing the actual torque;

FIG. 36F is a diagram that is a simulation result when assuming that the control object P(s) is equivalent to the identified model Pₙ(s) showing the distance from the braking is started until the vehicle stops;

FIG. 37A is a diagram that is the model Pₙ(s) such that a resonance frequency of the control object P(s) is identified and simulation results in the case of performing the control giving a modeling error of 5% and in the case without the control, showing the pitch rate;

FIG. 37B is a diagram that is the model Pₙ(s) such that a resonance frequency of the control object P(s) is identified and simulation results in the case of performing the control giving a modeling error of 5% and in the case without the control, showing the pitch angle;

FIG. 38A is a diagram that is an experimental result of the pitching control device according to the third embodiment of the present invention and (a) is a diagram showing the measured pitch rates in the case with the control and in the case without the control, respectively;

FIG. 38B is a diagram that is an experimental result of the pitching control device according to the third embodiment of the present invention, and shows the pitch angles estimated in the case with the control and in the case without the control, respectively;

FIG. 38C is a diagram that is an experimental result of the pitching control device according to the third embodiment of the present invention, and shows the accelerations in the case with the control and in the case without the control, respectively;

FIG. 38D is a diagram that is an experimental result of the pitching control device according to the third embodiment of the present invention, and shows a command value and the slip ratios in the case with the control and in the case without the control, respectively;

FIG. 38E is a diagram that is an experimental result of the pitching control device according to the third embodiment of the present invention and shows the wheel speed and the car body speed; and

FIG. 38F is a diagram that is an experimental result of the pitching control device according to the third embodiment of the present invention and shows the distances from starting the braking until the vehicle stops in the case with the control and in the case without the control, respectively.

### BEST MODE FOR CARRYING OUT THE INVENTION

Embodiments of the present invention that are described below will be explained as they are installed to an electronic control unit of a motor vehicle (hereinafter referred to as an “ECU”) that drives its driving wheels by a torque of a motor. Although a current outputted from a power source is supplied to the motor through an inverter, the motor is electrically connected to the ECU serving as control means through the inverter. That is, the output of the motor is controlled by the inverter for controlling an output current based on the command from the ECU. The ECU is a device that includes a CPU, ROM, RAM, an input/output port, a storage device, etc., and can electrically connect to a torque measuring instrument for measuring a generated torque of the motor, a position sensor installed on the motor, an acceleration sensor for measuring an acceleration arising in the car body, etc. through an inverter.

### First Embodiment

### 1. Outline of First Embodiment

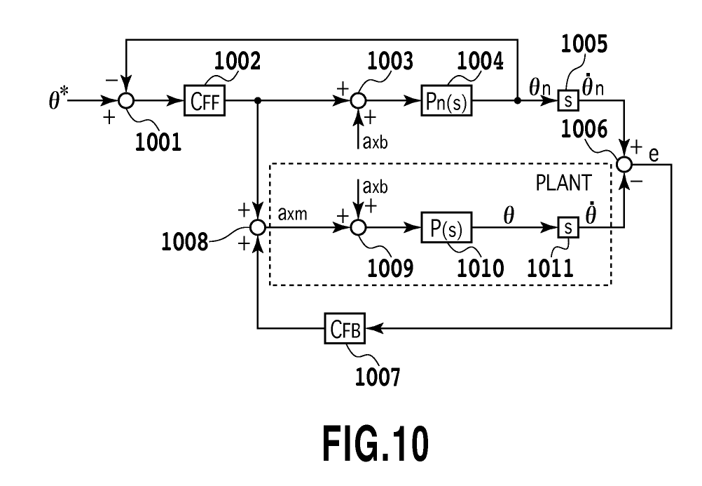

FIG. 10 shows a block diagram of a control system of a pitching control device according to a first embodiment of the present invention. As will be described later, the nominal plant Pₙ(s) is modeled so as to compute the pitch angle θ from a moment M about a point of the center of gravity of a vehicle based on variations of loads of the wheels considering an anti-dive force and an anti-lift force, in addition to loads applied to the wheels at the time of standstill and variations of loads applied to the wheels at the time of acceleration and deceleration by the torque of the motor.

When inputting an acceleration a_{xb} by a braking force into the nominal plant Pₙ(s), it outputs a motor acceleration aₓₘ that a feedforward controller C_{FF} ideally controls based on a pitch angle command value θ* and a nominal pitch angle θₙ outputted from the nominal plant Pₙ(s). The acceleration a_{xb} by the braking force is the acceleration aₓ of the car body measured by the acceleration sensor from which the acceleration aₓₘ by the motor that is computed based on the current value to the motor is subtracted.

When the acceleration aₓₘ outputted from the feedforward controller C_{FF} and the acceleration a_{xb} by the braking force are inputted into an actual plant P(s), the actual plant P(s) outputs the pitch angle θ. The pitch angle θ was differentiated.

A feedback controller C_{FB} compensates for the motor acceleration aₓₘ based on a difference between

[Formula 4]

pitch rate θ^{·}

(θdot) and a pitch rate θₙdot obtained by differentiating the nominal pitch angle θₙ.

Since feedback control is performed in this way, the compensation resists being influenced by a modeling error.

Hereafter, a pitching motion model will be described in detail. Since a pitching motion is a rotational motion about an axis that is vertical to a traveling direction and also vertical to a road surface (y-axis in the case of setting an x-axis to the traveling direction in a plane parallel to the road surface), A transfer function of front-rear two wheels considering the acceleration is found and a plant model is created. While doing this, a difference of the pitching effect between in-wheel driving and non-in-wheel driving will be described, and effects of anti-dive and anti-lift by the braking force will be also explained. Since in the present invention, identification based on experimental data is performed for the created pitching motion model and the pitching is controlled based on the identified model, an identification method and an experimental result are also described below.

### 2. Modeling of Pitching Motion and Derivation of Transfer Function

<2a-1> Half Car Model

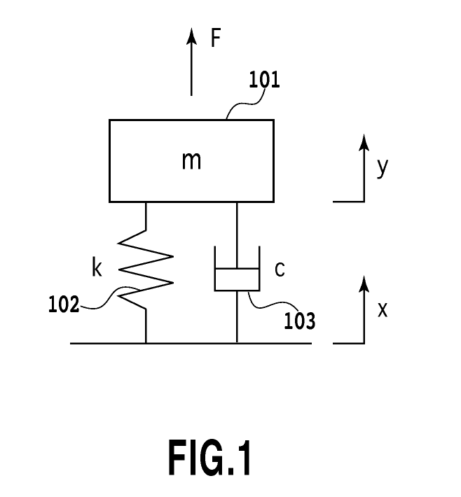

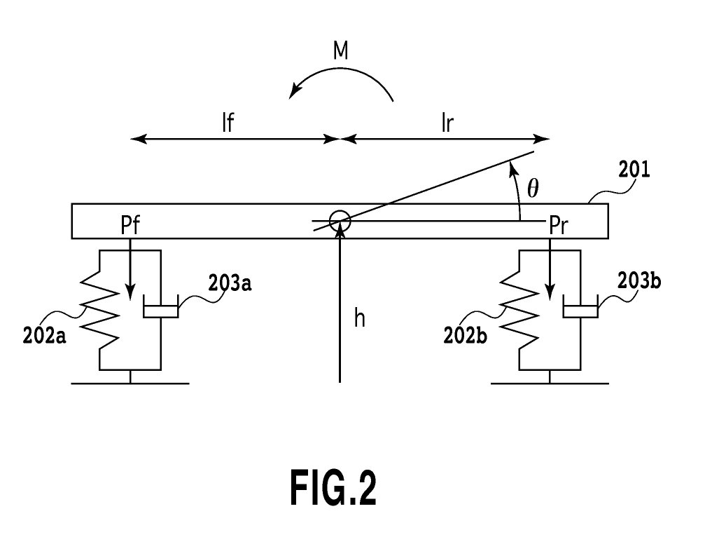

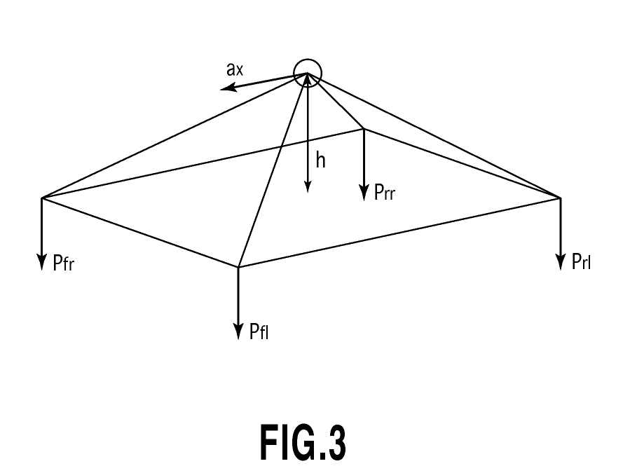

Pitching is a posture change of the car body, and can be approximated with a model considering only the car body (body on spring). Moreover, since it is a motion in a longitudinal direction, it can be thought in a model of the front-rear two wheels (half car model). Therefore, it can be expressed by a half car model as in FIG. 2 (refer to Nonpatent Document 4) A transfer function of a 1-degree-of-freedom model as in FIG. 1 can be expressed by

$$\begin{matrix}[ Formula 5 ] & \\ \frac{y}{F} = \frac{1}{{ms}^{2} + cs + k} & ( 1 )\end{matrix}$$

Although a vertical motion is thought in the 1-degree-of-freedom model, since the half car model considers a rotation system, a car body weight m can be replaced with a car body moment of inertia I. In addition, expressing the spring constant k and a damper coefficient c by C, K, respectively, in the half car model, the half car model can be considered equivalent to the 1-degree-of-freedom model. Therefore, a transfer function of the half car model can be expressed as by the following formula (refer to Nonpatent Document 4).

$$\begin{matrix}[ Formula 6 ] & \\ \frac{θ}{M} = \frac{1}{{Is}^{2} + Cs + K} & ( 2 )\end{matrix}$$

However, I[kgm²] is a moment of inertia about the y-axis of the car body, C[Ns/m] is a damper coefficient, K[N/m] is a spring constant, θ[rad] is a pitch angle, and Pf and Pr[N] are loads applied to front-rear wheels at the time of acceleration, respectively.

### <2-2> Load Variation by Longitudinal Acceleration

The pitch motion occurs when the vehicle is accelerated and decelerated. For this reason, in order to consider the acceleration, a variation of the load by the longitudinal acceleration is thought. Designating the longitudinal acceleration by aₓ, the loads of the respective wheels under steady motion become the following formulae (refer to Nonpatent Document 5)

$$\begin{matrix}[ Formula 7 ] & \\ {P}_{fr} = \frac{{N}_{f}}{2} - {a}_{x} m \frac{h}{{l}_{f} + {l}_{r}} & ( 3 ) \\ {P}_{fl} = \frac{{N}_{f}}{2} - {a}_{x} m \frac{h}{{l}_{f} + {l}_{r}} & ( 4 ) \\ {P}_{rr} = \frac{{N}_{r}}{2} + {a}_{x} m \frac{h}{{l}_{f} + {l}_{r}} & ( 5 ) \\ {P}_{rl} = \frac{{N}_{r}}{2} + {a}_{x} m \frac{h}{{l}_{f} + {l}_{r}} & ( 6 )\end{matrix}$$

However, P_{fr}, P_{fl}, Pᵣᵣ, and Pᵣₗ[N] were loads of the wheels, respectively, N_{f} and Nᵣ[N] are loads of the front-rear wheels at the time of standstill, respectively, m[kg] is a vehicle weight, h[m] is a height of a point of the center of gravity, and l_{f}, lᵣ[m] are distances from the point of the center of gravity to front/rear wheel shafts, respectively.

Since it is thought in the half car model, loads in the front-rear wheels are thought. At this time, the loads become the next formulae.

$$\begin{matrix}[ Formula 8 ] & \\ {P}_{f} = {N}_{f} - 2 {a}_{x} m \frac{h}{{l}_{f} + {l}_{r}} & ( 7 ) \\ {P}_{r} = {N}_{r} + 2 {a}_{x} m \frac{h}{{l}_{f} + {l}_{r}} & ( 8 )\end{matrix}$$

P_{f} and Pᵣ are loads applied to front wheels and rear wheels, respectively. Here, the moment M[nm] about a point of the center gravity of FIG. 2 is expressed by

[Formula 9]

M=P_{f}l_{f}−Pᵣlᵣ (9)

if Formulae (7), (8) are substituted into Formula (9), which is substituted into Formula (2), it will be expressed as follows.

$$\begin{matrix}[ Formula 10 ] & \\ θ = \frac{{N}_{f} {l}_{f} - {N}_{r} {l}_{r}}{{Is}^{2} + Cs + K} - \frac{2 {a}_{x} mh}{{Is}^{2} + Cs + K} & ( 10 )\end{matrix}$$

Since the first term of the right-hand side of the above formula is a moment at the time of standstill, it becomes zero. Thereby, it can be expressed as the following formula.

$$\begin{matrix}[ Formula 11 ] & \\ θ = - \frac{2 mh}{{Is}^{2} + Cs + K} {a}_{x} & ( 11 )\end{matrix}$$

From the above, a transfer function from the acceleration aₓ[m/s2] to the pitch angle θ was able to be expressed.

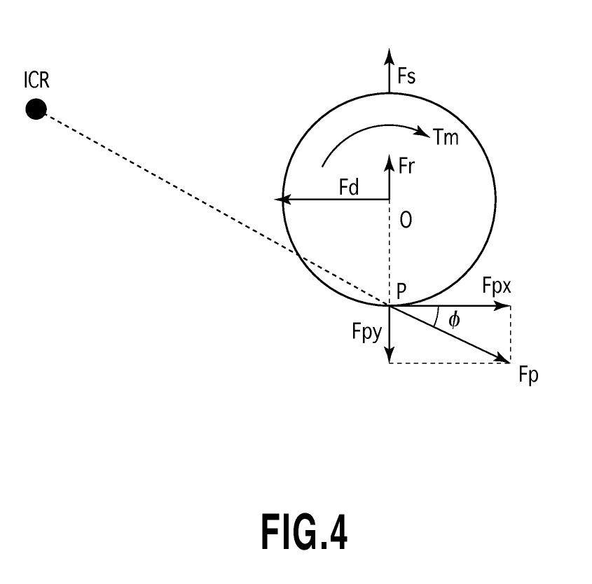

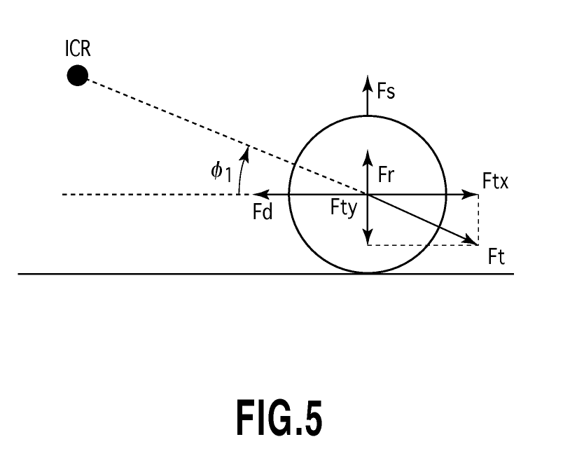

Pitching suppression effect at the time of start <3-1> FIG. 4 shows the effect in the case of the in-wheel type driving. In the case of the in-wheel type driving, since the motor is placed under a suspension, it has a mechanism that a force is received from on the suspension through an upper arm and a lower arm. A rotation force of the motor works as a force of balance to this force, and a place where exact balance is achieved is thought to be the ground plane of the wheel. From this, an action point of a driving force is thought to be on the ground plane of the wheel (refer to Nonpatent Document 6). At this time, a force of Fₚ works on the ground plane and can be decomposed into Fₚₓ and F_{py}. When a balance of forces in the horizontal direction is thought, Fₚₓ=F_{d} can be assumed. F_{d} is the driving force. Moreover, when a balance of forces in the vertical direction is thought, considering that Fᵣ is a vertical load of the rear wheels (a load at the time of acceleration+a load at the time of standstill), a formula

$$\begin{matrix}[ Formula 12 ] & \\ \begin{matrix}{F}_{s} = {F}_{py} - {F}_{r} \\ = {F}_{px} tan φ - {F}_{r} \\ = {F}_{d} tan φ - {F}_{r}\end{matrix} & ( 12 )\end{matrix}$$

holds, and F_{d} tan φ becomes a force for controlling the pitching and Fₛ becomes a force actually working.

<3-2> Non-in-Wheel Type Driving

Contrary, in the case of non-in-wheel type driving (drive shaft driving), since the motor is installed on the suspension, it is not necessary to support the rotation force of the motor under the suspension. That is, since under the suspension, a couple of forces is not generated, the action point of the force is concentrated to the center of the wheel (refer to Nonpatent Document 6). Thereby, F₃ can be expressed by the following formula similarly with the case of the in-wheel driving.

[Formula 13]

Fₛ=F_{d} tan φ₁−Fᵣ (13)

Thereby, in the case of non-in-wheel motor, although a force F_{d} tan φ1 for controlling the pitching works, since it is φ>φₗ, it becomes tan φ>tan φₗ, and it turns out that in in-wheel motor driving, the pitching control effect is larger than that of non-in-wheel driving.

<3-3> Comparison of Pitching Effect by Simulation

For reference, a simulation in the open loop at the time of start is performed in the case of the in-wheel type driving and in the case of drive shaft driving, respectively.

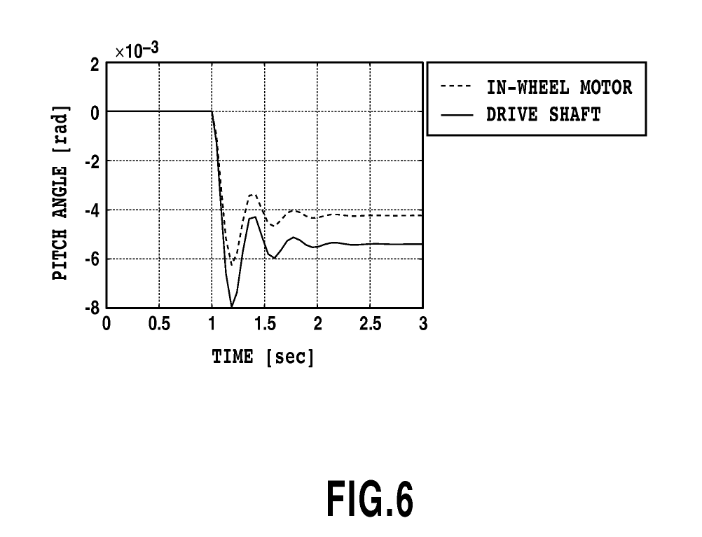

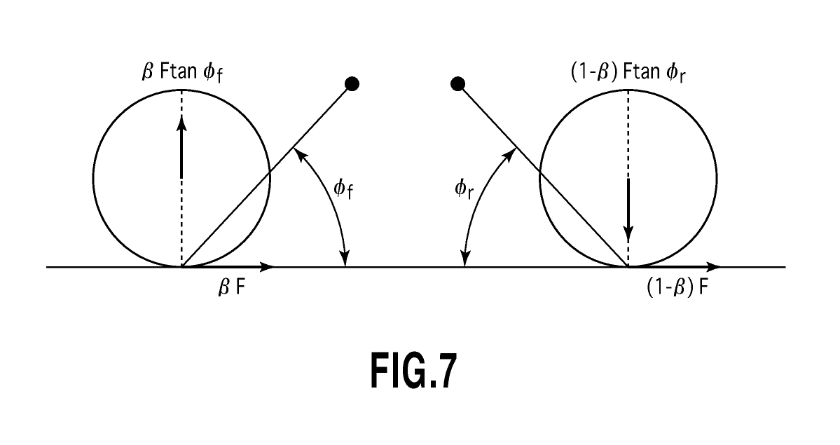

As will be described in later Chapter 5, the simulation was performed based on a pitching model that was found by an identification experiment. In doing this, the acceleration is set to be in the form of a step input with aₓ=1.0 m/s² at t=1.0 s, and FIG. 6 shows pitch angles when values of φ are set to φ=30 and 20 degrees in the case of the in-wheel driving and in the case of the drive shaft driving, respectively. This diagram indicates that the pitching is smaller in the case of the in-wheel type driving than that in the other case.

### 4. Anti-Dive and Anti-Lift Geometry at the Time of Braking

At the time of the start, the pitching effect in the in-wheel motor discussed in Chapter 3 can be considered. Since a force by the brake works at the time of the braking and a force by the motor does not work, an anti-dive and anti-lift geometry by the braking force as in the below is thought (refer to Nonpatent Document 7).

At the time of the braking, the braking forces work on the front and rear wheels. Designating a braking force distributed to the front wheel by β, when the total braking force working on the front and rear wheels is F, a front wheel braking force becomes βF and a rear wheel braking force becomes (1−β)F . Since the brake torque is transferred to the suspension through a brake unit, it is thought that a virtual action point of the force is on the ground plane: the anti-dive force βF tan φ_{f} works on the front wheel and the anti-lift force (1−β)F tan φᵣ works on the rear wheel.

Modeling is conducted again considering this. The loads of the front and rear wheels are expressed by

$$\begin{matrix}[ Formula 14 ] & \\ {P}_{f} = {N}_{f} - 2 {a}_{x} m \frac{h}{{l}_{f} + {l}_{r}} - β F tan {φ}_{f} & ( 14 ) \\ {P}_{r} = {N}_{r} + 2 {a}_{x} m \frac{h}{{l}_{f} + {l}_{r}} + ( 1 - β ) F tan {φ}_{r} & ( 15 )\end{matrix}$$

respectively, and a moment of the force is expressed as follows because F=−max with running resistance ignored.

M=−2mhαₓ−(mβl_{f} tan φ_{f}+m(1−β)lᵣ tan φᵣ)αₓ(16) [15]

A transfer function becomes

$$\begin{matrix}[ 16 ] & \\ θ = \frac{- 2 mh - m ( β {l}_{f} tan {φ}_{f} + ( {1}^{′} - β ) {l}_{r} tan {φ}_{r} )}{{Is}^{2} + Cs + K} {a}_{x} & ( 17 )\end{matrix}$$

where the first term of the numerator of the right-hand side is an inertia force and the second term is a term that is appeared by the braking force working on the ground plane. Although this time the pitching control at the time of the braking is performed based on this model, they are identified based on experimental data about the model of the above formula because there are many unknown parameters.

### 5. Parameter Identification and Experimental Result

Since the parameters of the model that was found until the preceding paragraph are unknown, it is necessary to identify them. Then, the identification experiment was conducted.

<5-1> Actual Device Specifications

For an experimental machine, a commercially available small-sized electric vehicle EV-1 (Qi(QUNO), a product of CQMOTORS) was modified and is being used.

The motor is controlled using an inverter system manufactured in cooperation with Myway Corporation. Moreover, since a resolution of a hall sensor of the motor is low, vector control is performed by carrying out linear interpolation of a position angle. A sampling period shall be 10 kHz.

<5-2> Parameter Identification

Experimental conditions are such that the acceleration aₓ is given in a step form and that the braking force may become constant by disposing a member for fixing a brake pedal on the reverse side of it at that time.

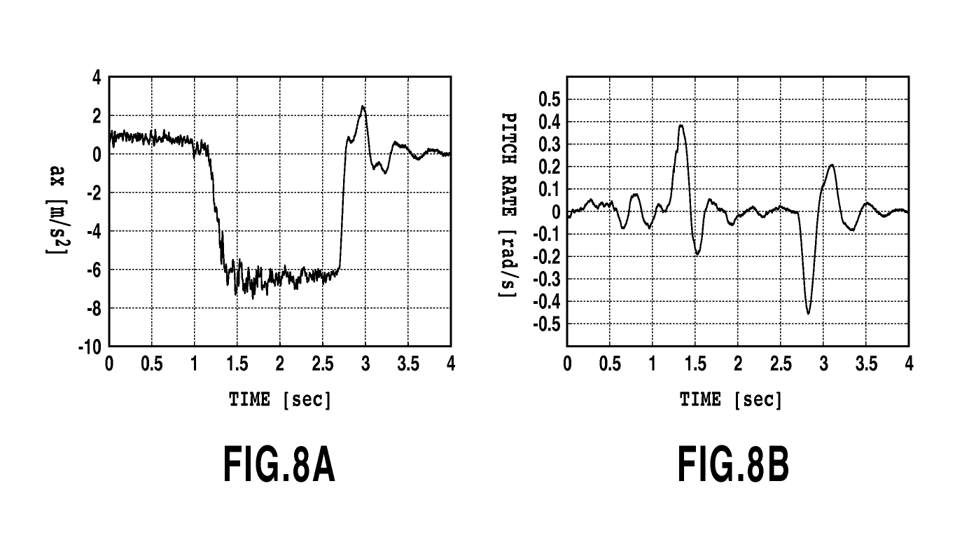

Moreover, for the pitch rate θdot, since there is no pitch angle sensor in this laboratory, the experiment was conducted with a yaw sensor attached to the y axis. FIG. 8A and FIG. 8B show experimental results (acceleration, pitch rate) at that time. From this experimental result, identification was performed by setting the input to the acceleration aₓ and setting the output to the pitch rate θdot.

As the identification method, in this paper, the parameters of the transfer function are found so that outputs to the inputs of FIG. 8A and FIG. 8B may fit to them in a time domain. The transfer function is shown below,

$$\begin{matrix}[ Formula 17 ] & \\ G ( s ) = \frac{- 336 s}{162.9 {s}^{2} + 1250 s + 45500} & ( 18 )\end{matrix}$$

At this time, the natural angular frequency was ωₙ=16.7 rad/s and the attenuation constant was C=0.23.

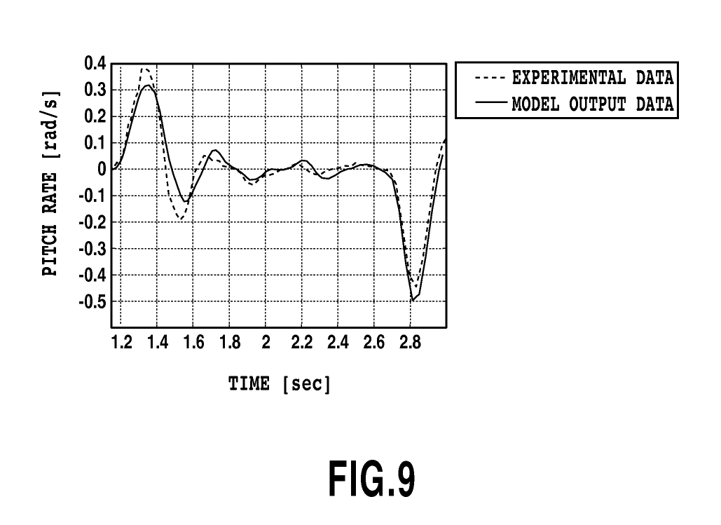

Moreover, FIG. 9 shows a verification result in this identified model. This diagram indicates that the experiment data and the output data of the identified model have mutually close waveforms to each other.

Since Formula (18) is a transfer function of acceleration input and pitch rate output and the pitch rate is a differentiated pitch angle, a transfer function of acceleration input and pitch angle output is expressed as in the following formula.

$$\begin{matrix}[ Formula 18 ] & \\ G ( s ) = \frac{- 336 s}{162.9 {s}^{2} + 1250 s + 45500} & ( 19 )\end{matrix}$$

In the first embodiment, control of pitching used in this model is performed.

### 6. Simulation Result

Denoting a driving force of the braking force by F_{xb} and denoting a driving force by the motor by Fₓₘ, it is assumed that Fₓ can be expressed by the following formula in a driving force dimension.

[Formula 19]

Fₓ=F_{xb}+Fₓₘ (20)

By dividing both sides of Formula (20) by m, from the formula of Fₓ=maₓ, it can be expressed by

[Formula 20]

αₓ=α_{xb}+αₓₘ (21)

a_{xb} is an acceleration by the braking force, and aₓₘ is an acceleration by the motor. Based on this formula, a control system by a 2-degree-of-freedom control system as in the block diagram of FIG. 10 is proposed. This control system obtains aₓₘ that ideally controls the pitch angle with C_{FF} having a sufficiently high gain when giving an acceleration by the braking force as an input to the nominal plant Pₙ(s) having a transfer function of Formula (19) being identified in Chapter 5. This is applied to the actual plant P(s) as a motor torque. When the actual plant is the same as the nominal plant, it becomes possible to suppress the pitching with this motor torque. When there is the modeling error, a motor torque such that a difference of the pitch rate that is an output from the actual plant and the pitch angle that is found by pseudo-differentiating the pitch angle that is an output of the nominal plant with a bypass filter is compensated by the feedback controller C_{FB} is applied to the actual plant. Thereby, the device can have high controllability even when there is the modeling error. The simulation of the pitching control is performed by this control system. At this time, constants are r=0.22 m, m=420 kg, and for parameters of the nominal plant, the values identified in Chapter 5 were used.

As simulation conditions, the pitch angle, the pitch rate, a car body speed, and the car body position until the vehicle stops shall be observed by giving the vehicle traveling at a constant speed quick braking at t=1.0 s and later. Moreover, in order to make the simulation have the modeling error, the spring coefficient and the damper coefficient of Pₙ(s) and P(s) were set as Cₙ=500 Ns/m, Kₙ=45500 N/m, C=500 Ns/m, and K=45000 N/m, respectively. The C_{FF} and C_{FS} are designed by the pole assignment technique as a PD controller and a PI controller, respectively.

<6-1> Simulation 1

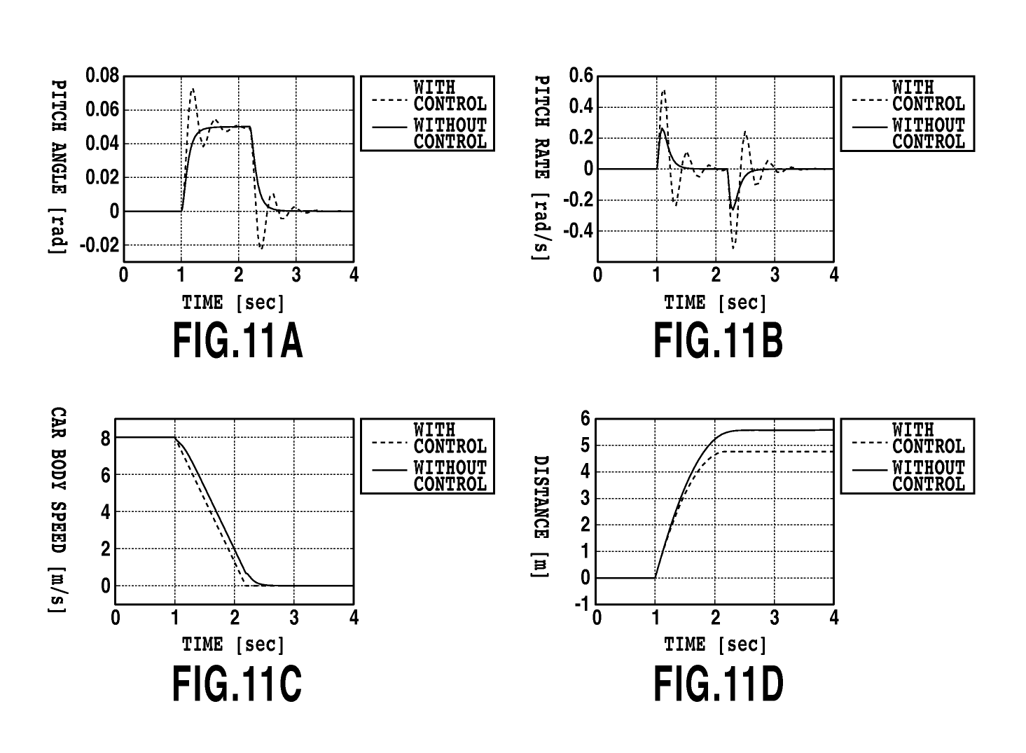

First, FIG. 11A to FIG. 11D show results of comparison performed by a simulation between a case without the control of the open loop and a case with the control. At this time, the values of the closed loop poles of C_{FF} and C_{FB} were set to 17 rad/sec and 10 rad/sec, respectively. FIG. 11A and FIG. 11B indicate that the pitch angle and the pitch rate are well controlled, respectively. However, FIG. 11D shows that the distance until the vehicle stops has elongated considerably.

<6-2> Simulation 2

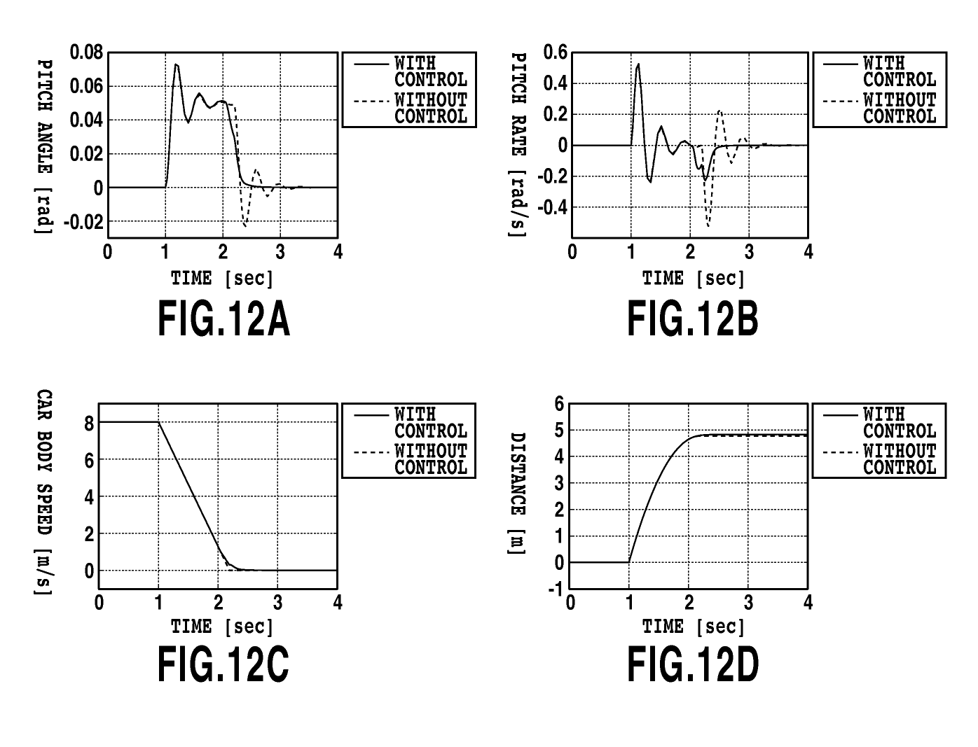

In order to solve the problem of the simulation 1, a simulation where the control was imposed when the car body speed V became smaller than 1.0 m/s was performed. The results are FIG. 12A to FIG. 12D. At this time, values of the closed loop poles of C_{FF} and C_{FB} were set to 23 rad/sec and 10 rad/sec, respectively. FIG. 12D indicates that a distance necessary to stop is almost not changed, compared with a case without the control. However, since the control starts to be imposed when the car body speed V become smaller than 1 m/s, the pitch rate is controlled only at a time of 2.04 s and later.

### 7. Real Machine Verification

Real machine verification was performed for the simulation result of Chapter 6. As conditions in the experiment, quick braking is applied from a constant speed on a dry road, similarly with the identification experiment in Chapter 5. At that time, the braking force was made to become constant. Acceleration a_{xb} by the braking force that serves as an input to the nominal plant shall be an output a from the acceleration sensor from which an acceleration aₓₘ by the motor that becomes an input to the actual plant is subtracted by Formula (21). For values of the closed loop poles of C_{FF} and C_{FB}, the same values as the case of the simulation were used. A case with the control and a case without the control at that time are compared and examined. Pieces of measured data are the acceleration aₓ,

[Formula 21]

pitch rate θ^{·},

a wheel speed V_{ω}, and torque T.

<7-1> Experiment 1

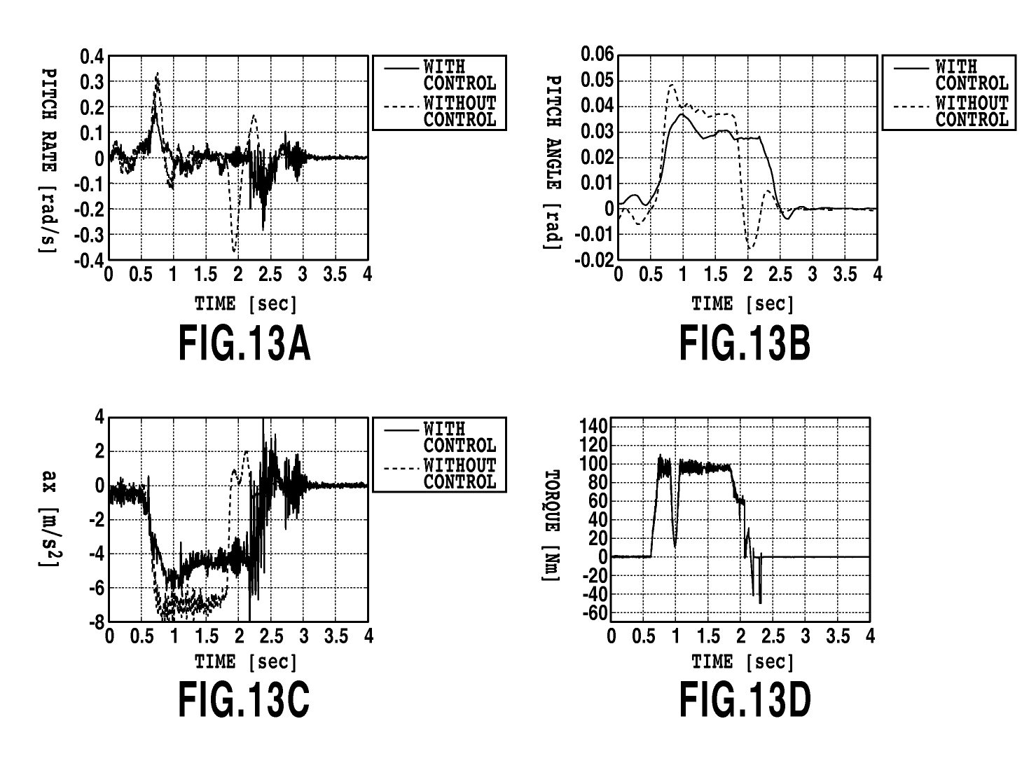

First, an experiment about the simulation 1 of Chapter 6 was conducted. Experimental results at this time are shown in FIG. 13A to FIG. 13D. FIG. 13A, FIG. 13B, and FIG. 13C are results of comparison of

[Formula 22]

an output pitch rate θ^{·}

from the angular velocity sensor, a pitch angle θ found by pseudo-differentiating the pitch rate with a bypass filter, and the acceleration aₓ at that time in the case with the control in the case with the control and in the case without the control, and FIG. 13D is an actual torque T in the case with the control.

The experimental results of FIG. 13A indicate that in the case with the control, the pitch rate is being controlled, compared with the case without the control. Moreover, FIG. 13B indicates that the pitch angle is also controlled in the case with the control, compared with the case without the control.

Further, FIG. 13C indicates that in the case with the control, the acceleration is controlled, compared with the case without the control and the distance until the vehicle stops has elongated.

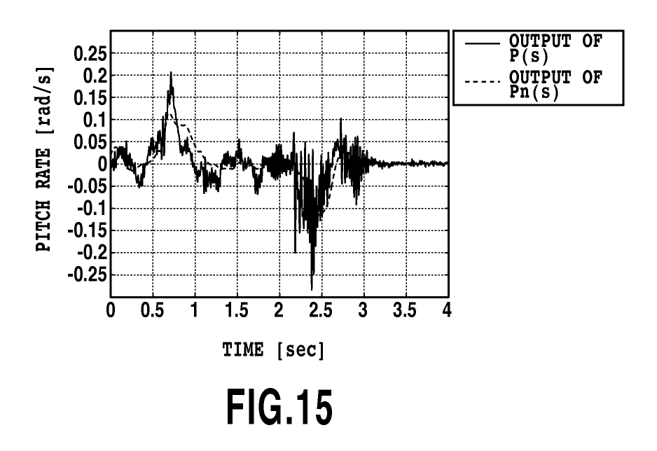

FIG. 15 shows a comparison of the output pitch rates from P(s) and Pₙ(s), respectively, showing that the output of P(s) does not follow the output of Pₙ(s) completely.

<7-2> Experiment 2

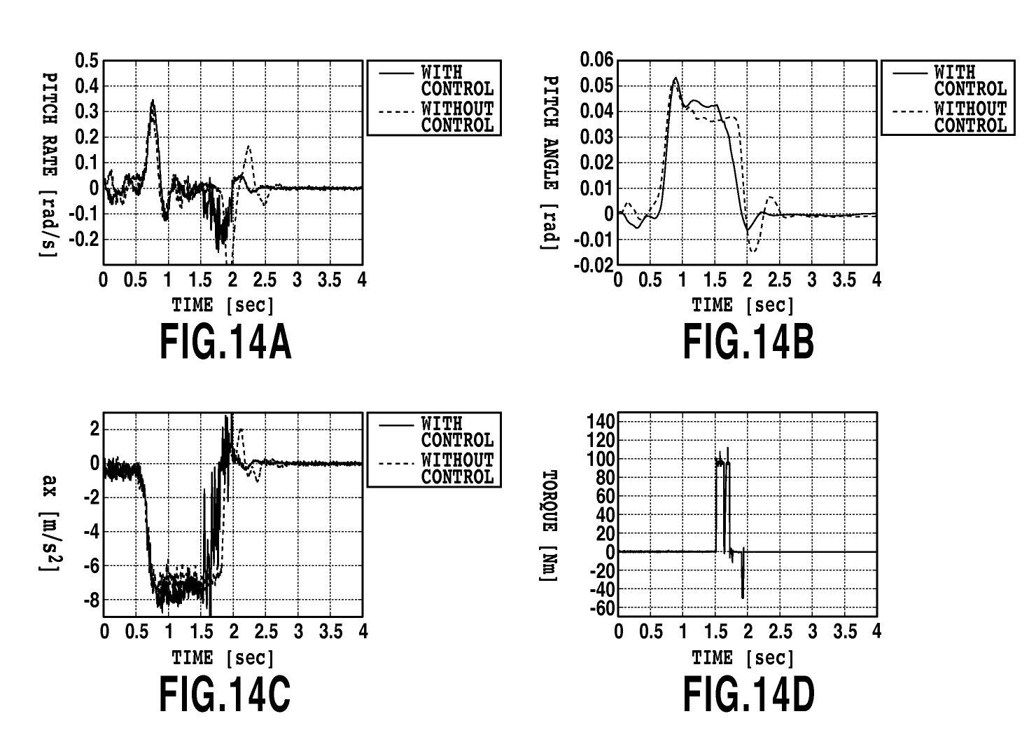

Next, real machine verification in a simulation 2 was performed. Since the experiment was conducted on the dry road, the control was started when the wheel speed reached about 3 km/h assuming that slip was minute. FIG. 14A to FIG. 14D show experimental results at this time. The pitch rate, the pitch angle, the acceleration, and the actual torque are shown, respectively, similarly with the case of Experiment 1.

Also in this case, FIG. 14A and FIG. 14B show that both the pitch rate and the pitch angle are controlled like the simulation result.

Moreover, FIG. 14C indicates that since the control is imposed just before the stopping, the acceleration becomes small only just before the stopping. By this, the distance until the vehicle stops does not elongate so much compared with the case of Experiment 1.

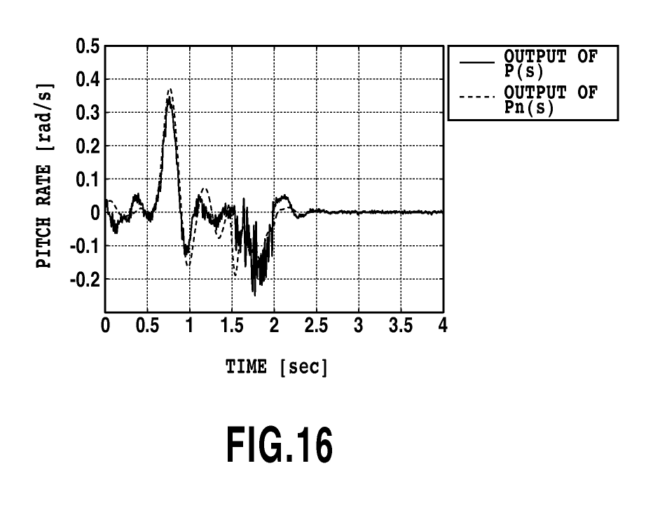

FIG. 16 compares the output pitch rates of P(s) and Pₙ(s) similarly with FIG. 15, and a small error occurs although the both show close waveforms to each other. It is thought that this is also caused by the same reason as that in FIG. 16.

### Second Embodiment

In the first embodiment, the acceleration a_{xb} by the braking force is derived from the acceleration aₓ of the car body measured by the acceleration sensor and the acceleration aₓₘ by the motor computed based on a current value outputted to the motor. However, since the acceleration aₓₘ by the motor is affected by a road surface state in a stricter sense, it is desirable to derive the acceleration considering the road surface state. Thereupon, in a second embodiment, the acceleration aₓ of the car body is derived from an equation of motion of the vehicle.

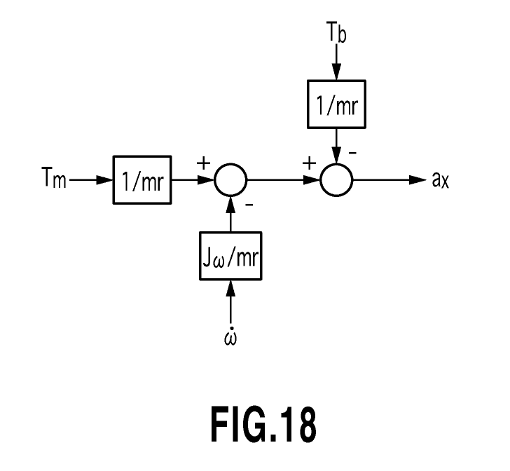

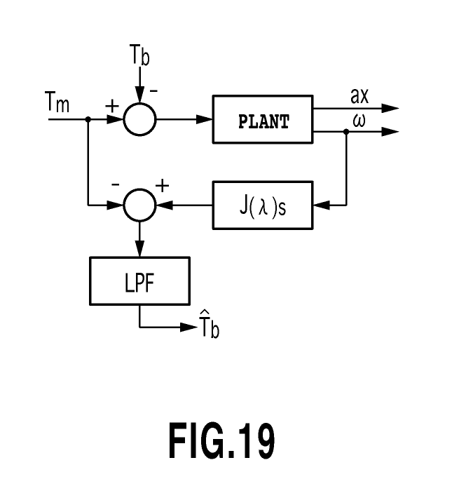

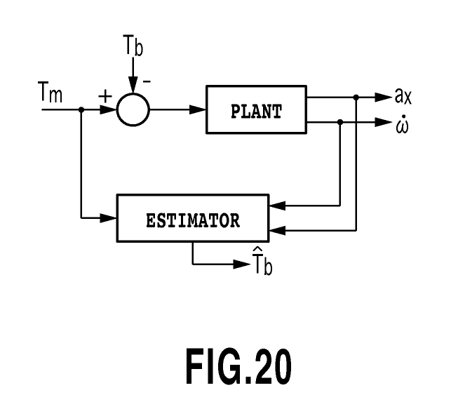

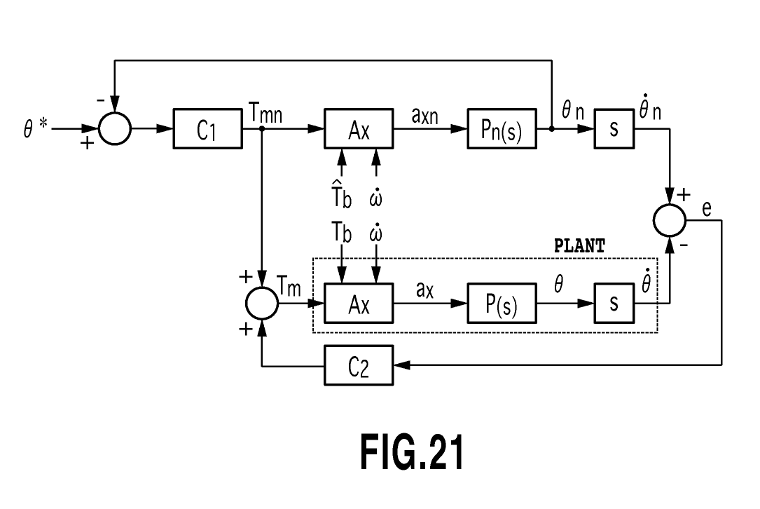

FIG. 21 shows a block diagram of a control system using brake torque estimation of the pitching control device according to the second embodiment of the present invention. The nominal plant Pₙ(s) is modeled so as to compute the pitch angle θ from the moment M about the point of the center of gravity of the motor vehicle based on variations of the loads of the wheels that consider the anti-dive force and the anti-lift force, similarly with the first embodiment. Aₓ in FIG. 21 becomes a longitudinal acceleration estimator of FIG. 18. Moreover, an estimated value of a brake torque T_{b} is inputted into Aₓ from the estimator considering the slip ratio shown in FIG. 19 or the estimator using the acceleration aₓ of the car body by the acceleration sensor shown in FIG. 20. ωdot is a value obtained by differentiating the wheel speed ω by time.

This control system computes a nominal acceleration aₓₘ from the brake torque T_{b} computed by a brake torque estimator, and when the nominal acceleration aₓₘ is given to the nominal plant Pₙ(s) it obtains a nominal motor torque Tₘₙ that is ideally controlled by the feedforward controller C₁. By applying this to the actual plant P(s) as the motor torque, if the actual plant is the same as the nominal plant, it becomes possible to suppress the pitching by this motor torque.

When there is the modeling error in the nominal plant Pₙ(s), a motor torque Tₘ such that a difference between the pitch rate that is an output from the actual plant and the nominal pitch rate that is a derivative value of the pitch angle being an output of the nominal plant Pₙ(s) is compensated by a feedback controller C₂ is applied to the actual plant together with the nominal motor torque Tₘₙ. Thereby, even if there is the modeling error, it becomes possible to have high controllability.

In the second Embodiment, by performing the pitching control on the first embodiment using a brake torque estimated considering the slip ratio, it is possible to perform a further high-accuracy pitching control.

Based on contents of Chapters 1 to 4, a second embodiment will be explained in detail below.

### 9. Parameter Identification

Similarly with the first embodiment, the second embodiment also performs th control based on a model where a moment of a force and a transfer function of acceleration input and pitch rate output are given by Formulae (16), (17), respectively. Since the second embodiment uses an experimental vehicle different from that of the first embodiment, unknown parameters were identified based on a below-mentioned experiment similarly with the case of the first embodiment.

<9-1> Real Machine Specifications

For the experimental machine, a commercially available small-sized electric vehicle EV-3 (COMS LONG BASIC) is modified and is being used. The use of the inverter motor is the same as the experimental vehicle EV-1 used in the first embodiment.

<9-2> Parameter Identification

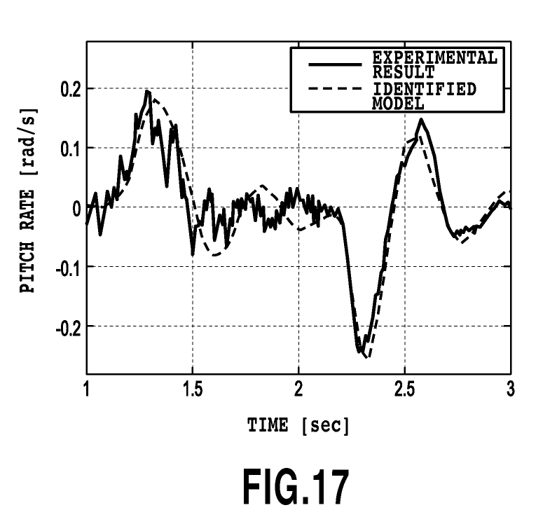

The experiment was conducted under the same conditions as the case of the first embodiment. FIG. 17 shows a result obtained by comparing the pitch rate of the experimental result and the output pitch rate when the acceleration at that time is inputted to the identified model. As the identification method, in the second embodiment, parameters of the transfer function are found so that an output to the input of the acceleration may be fitted to the input in a time domain. The transfer function is shown below.

$$\begin{matrix}[ Formula 23 ] & \\ G ( s ) = \frac{- 264 s}{345.6 {s}^{2} + 1250 s + 70400} & ( 22 )\end{matrix}$$

At this time, a natural angular frequency was ω=14.3 rad/s and an attenuation constant was ζ=0.22. FIG. 17 indicates that, although a noise rides on the experimental result because a value of the pitch rate is small, it exhibits a close waveform.

Since Formula (22) is a transfer function of acceleration input and pitch rate output, and the pitch rate is a differentiated pitch angle, a transfer function of acceleration input and pitch angle output becomes Formula (22) that is integrated.

### 10. Method for Computing Nominal Acceleration

### <10-1> Nominal Acceleration

In the first embodiment described above, the acceleration that becomes an input of the plant is obtained by a sum of the acceleration by the motor and the acceleration by the braking force as shown by Formula (21). However, actually, aₓₘ is determined by the acceleration and the road surface state. Thereupon, in the present invention, a method for computing the acceleration considering the road surface state is proposed. First, an equation of motion of the vehicle will be shown below.

[Formula 24]

J_{ω}\dot{ω}=Tₘ−rF_{d}−T_{b} (23)

[Formula 25]

m\dot{V}=F_{d} (24)

[Formula 26]

V_{ω}=rω (25)

Variable are: the rotation speed ω[rad/s] of a motor, the car body speed V[m/s], the wheel speed V[m/s], the motor torque Tₘ[nm], the brake torque T_{b}[nm], and the driving force F_{d}[N]. Constants shall be: the car body weight m[kg], the tire radius r[m], the moment of inertia of the wheel rotation part J_{ω}[Nms²]. Obtaining aₓ from Formula (23) will give the following formula.

$$\begin{matrix}[ Formula 27 ] & \\ {a}_{x} = \frac{{T}_{m} - {T}_{b} - {J}_{ω} \dot{ω}}{mr} & ( 26 )\end{matrix}$$

FIG. 18 shows a block diagram showing the longitudinal acceleration estimator for estimating a longitudinal acceleration from the motor torque, the brake torque, and a wheel angular acceleration. Thereby, an acceleration considering the road surface state can be found. However, in Formula (26), since the motor torque Tₘ is measurable, and the wheel angular acceleration ωdot and the brake torque T_{b} cannot be measured, it is necessary to estimate it separately.

### <10-2> Brake Torque Estimation Method

In the second embodiment, as a brake torque estimation method, the following two techniques are proposed.

<10-2-1> Estimation Considering Slip Ratio

The method for estimating the brake torque considering the slip ratio will be proposed.

The slip ratio is expressed as follows.

$$\begin{matrix}[ Formula 28 ] & \\ λ = \frac{{V}_{ω} - V}{max ( {V}_{ω} , V )} & ( 27 )\end{matrix}$$

Obtaining the brake torque T_{b} by eliminating F_{d} and V from this Formula of the slip ratio (27) and Formulae (23) to (25), it is expressed by Formula (28) when V>V_{ω} holds, and by Formula (29) when V_{ω}>V holds, as described below.

$$\begin{matrix}[ Formula 29 ] & \\ {T}_{b} = {T}_{m} - \dot{ω} ( {J}_{ω} + \frac{{r}^{2} M}{1 + λ} ) + \frac{{r}^{2} M ω \dot{λ}}{{( 1 + λ )}^{2}} & ( 28 )\end{matrix}$$

[Formula 30]

T_{b}=Tₘ−\dot{ω}(J_{ω}+r²m(1−λ))+r²mω\dot{λ} (29)

Assuming that a slip ratio fluctuation is minute and approximating it with λdot=0, Formulae (28), (29) are summarized and can be written as follows, (as Formulae (30), (31)).

$$\begin{matrix}[ Formula 31 ] & \\ \dot{ω} = \frac{{T}_{m} - {T}_{b}}{{J}_{ω} + \frac{{r}^{2} m}{1 + λ}} = \frac{{T}_{m} - {T}_{b}}{{J}_{brake} ( λ )} & ( 30 )\end{matrix}$$

$$\begin{matrix}[ Formula 32 ] & \\ \dot{ω} = \frac{{T}_{m} - {T}_{b}}{{J}_{ω} + {r}^{2} m ( 1 - λ )} = \frac{{T}_{m} - {T}_{b}}{{J}_{acc} ( λ )} & ( 31 )\end{matrix}$$

FIG. 19 shows a block diagram showing a brake torque estimator considering the slip ratio. In FIG. 19, when V>V_{ω} holds, J becomes J(λ)=J_{brake}(λ); when V_{ω}>V(λ) holds, J becomes J(λ)=J_{acc}(\dot{λ}). From Formulae (30), (31), if the slip ratio is measurable, the brake torque T_{b} can be estimated by inputting the motor torque Tₘ and the wheel angular velocity ω that were measured.

<10-2-2> Estimation Using Acceleration Sensor

A method for estimating the brake torque T_{b} using the acceleration sensor will be shown. From Formula (23) and Formula (24), the brake torque can be found as follows.

[Formula 33]

\hat{T}_{b}=Tₘ−J_{ω}\dot{ω}−rmaₓ (32)

FIG. 20 shows a block diagram showing a brake torque estimator using the acceleration sensor. If an influence of the gravity of the acceleration sensor at the time of pitching can be corrected, the brake torque T_{b} can be estimated as shown in FIG. 20 by inputting the values of the motor torque Tₘ, the wheel angular acceleration ωdot, and the acceleration aₓ of the car body that were measured.

11.2-Degree-of-Freedom Control

FIG. 21 shows a block diagram showing a control system of a 2-degree-of-freedom control system of the pitching control device according to the first embodiment of the present invention. A symbol A in this figure becomes the longitudinal acceleration estimator of FIG. 18. Moreover, a symbol Aₓ is inputted with the brake torque T_{b}, the motor torque Tₘ, and the wheel angular acceleration ωdot from the estimator of FIG. 19 or FIG. 20. When the nominal acceleration aₓₙ that uses a brake torque estimated value is given to the nominal plant Pₙ(s) having a transfer function that was identified in Chapter 2, this control system ideally controls the pitch angle with C₁ having sufficiently high gain and obtains the nominal motor torque Tₘₙ. This will be applied to the actual plant P(s) as the motor torque. If the actual plant is the same as the nominal plant, it will become possible to suppress the pitching by this motor torque Tₘ.

When there is the modeling error, the motor torque Tₘ such that a difference between the pitch rate that is an output from the actual plant and the nominal pitch rate that is a derivative value of the pitch angle being an output of the nominal plant Pₙ(s) is compensated by the feedback controller C₂ is applied to the actual plant. Thereby, also when there is the modeling error, it becomes possible to have high controllability.

### 12. Simulation

A computer simulation was performed using a brake torque estimation method and a pitching control method that have been shown by the preceding chapter. Parameters used in the simulation are: the car body weight m=480 kg; the wheel radius r=0.22 m; and the wheel rotation part moment of inertia J_{ω}=1.0[Nms²]; the nominal plant Pₙ(s) is an identified model, and the actual plant P(s) is such that the spring and damper coefficients were C=2450 Ns/m and K=66000 N/m, respectively, in order to make it have the modeling error. Moreover, regarding the controller, C1 and C2 are designed by the pole assignment technique as a PD controller and a PI controller, respectively, and the values of respective closed loop poles were set to 21 rad/s and 10 rad/s, respectively.

The simulation conditions shall be such that when the vehicle is moving at a constant speed of 8.0 m/s on the high μ road, it is decreased in speed by being given a brake torque of 750 Nm, and is observed for a period until the vehicle stops. Moreover, since there was a problem that in the case where the control is always imposed, the braking distance will elongates, the control shall be started when the speed becomes small, and in this time the control shall start to be imposed when the car body speed becomes 1.0 m/s or less.

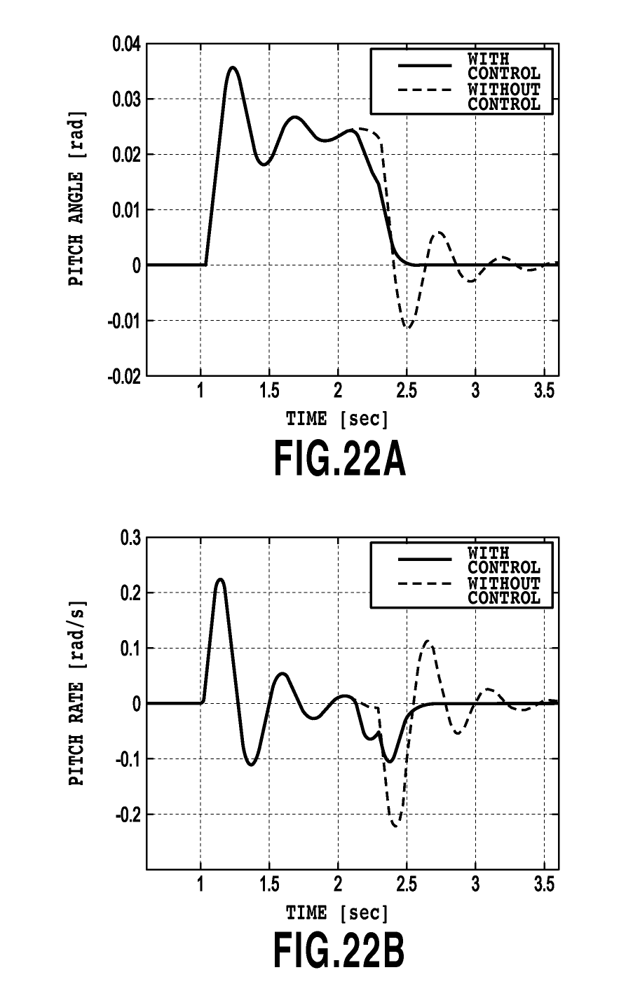

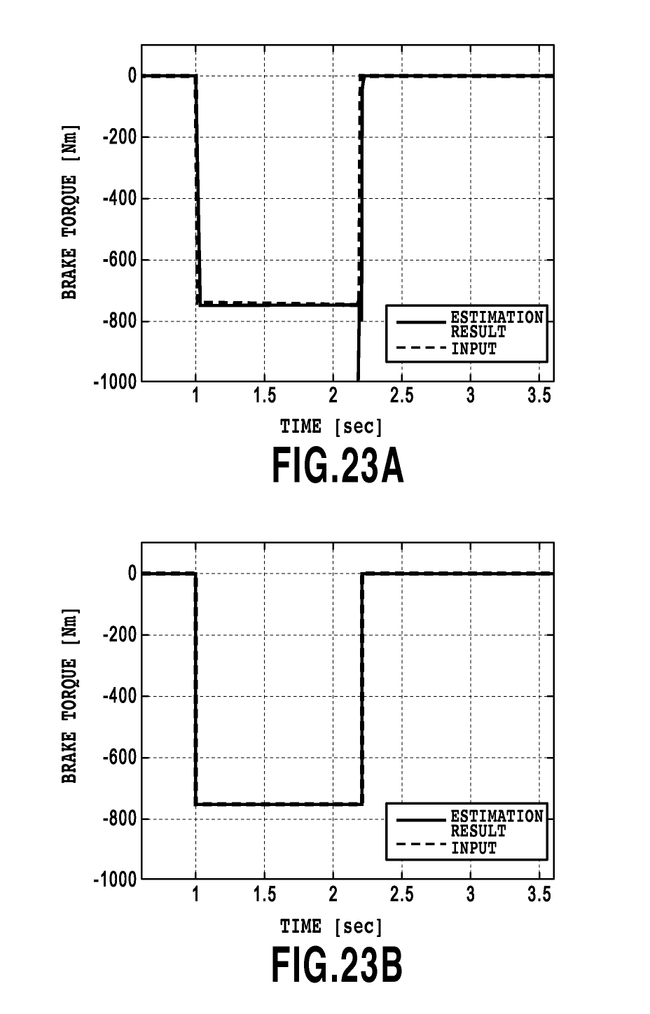

FIG. 22A and FIG. 22B show the pitch angle and the pitch rate in the case with the pitching control according to the first embodiment of the present invention and in the case without the control, respectively. Moreover, FIG. 23A and FIG. 23B show the brake torque estimated value in the case of considering the slip ratio and the estimated value in the case of using the acceleration sensor, respectively.

FIG. 22A and FIG. 22B indicate that in the case with the control according to the second embodiment, both the pitch angle and the pitch rate are controlled well compared with the case without the control. Moreover, although FIG. 23A shows the brake torque estimated value considering the slip ratio at that time, it indicates that it was able to be estimated accurately. Just before the stopping, the waveform is disturbed a little. It is thought that this was because a phenomenon where the wheel speed and the car body speed were reversed just before the stopping occurred, causing chattering. However, as is shown by FIG. 22A and FIG. 22B, the pitching can be controlled with sufficient accuracy in the second embodiment. Moreover, although FIG. 23B shows the brake torque estimated value by the estimation method using the acceleration sensor, this case indicates that the estimation can be done in a better way, and FIG. 22B indicates that accuracy of the pitching control is also increased.

### 13. Real Machine Verification

Next, the experiment was conducted using the real machine actually. Parameters used in the experiment are the car body weight m=480 kg and the wheel radius r=0.22 m, and for the parameters of the nominal plant, the identified values were used. Moreover, regarding the controllers, C1 and C2 were designed by the pole assignment technique as a PD controller and a PI controller, respectively. In this experiment, values of respective closed loop poles were set to 21 rad/s and 10 rad/s, similarly with the simulation.

As described above, since there is a problem that if the control is always imposed, the braking distance will elongates, the control shall be started when the speed becomes small. In this case, it shall be set that the vehicle is decelerated by a brake when it travels at a constant speed of about 28 km/h, and the control starts to be imposed when the car body speed becomes 4.5 km/h or less.

Moreover, although in this embodiment, the slip ratio is found by detecting the car body speed from the front wheels and the wheel speed from the rear wheels for simplification, one that is found by performing estimation of the slip ratio (refer to Nonpatent Document 8) may be used.

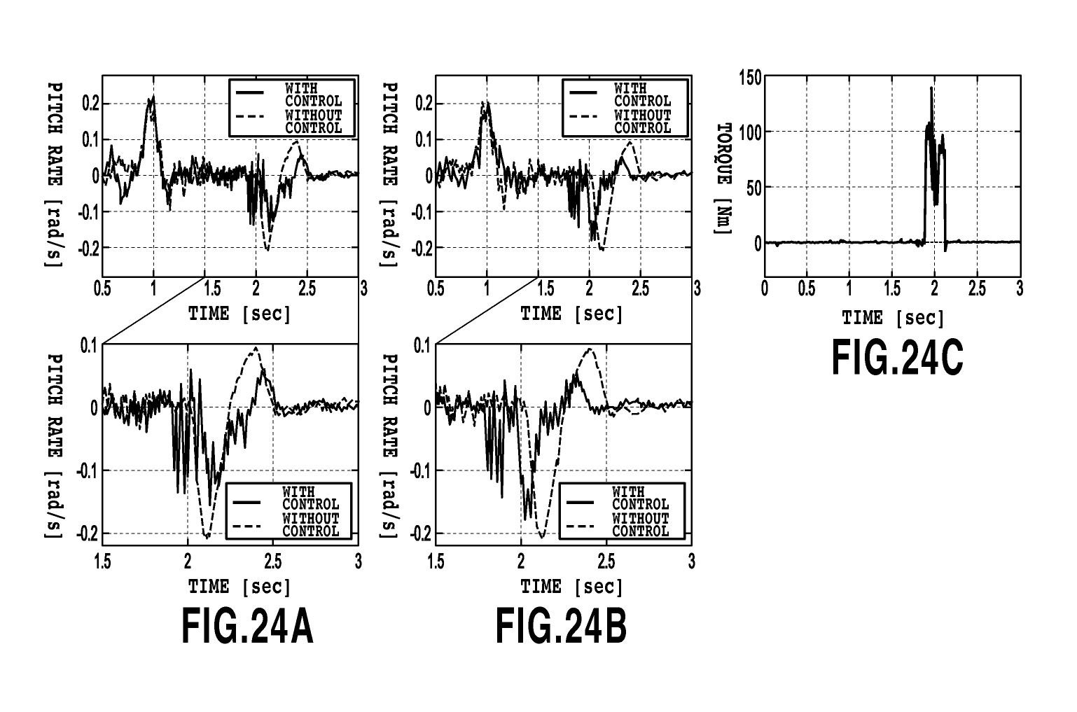

Below, experimental results of the pitching control that uses the brake torque estimation method considering the slip ratio and the brake torque estimation method using the acceleration sensor are shown. FIG. 24A shows the pitch rates in the case with the control that uses estimation considering the slip ratio according to one embodiment of the present invention and in the case without the control, respectively; FIG. 24B shows the pitch rates in the case with the control that uses estimation using the acceleration sensor according to the one embodiment of the present invention and in the case without the control, respectively. Moreover, Table 1 shows values of peak to peak of the pitch rates just before stopping (around 2 to 2.5 seconds).

TABLE 1

| | Peak-to-peak | ratio to case |
|---|---|---|
| | [rad/s] | without control [%] |
| Without control | 0.216 | 100 |
| With control (slip ratio) | 0.165 | 76.3 |
| With control (acceleration sensor) | 0.180 | 83.3 |

FIG. 24A, FIG. 24B, and Table 1 indicate that in the case where the control is imposed, the pitch rate is well controlled, compared with the case without the control.

Although in the experiment, the member acting as a stopper is disposed on the reverse side of the brake pedal so that the braking force may become constant through the entire experiment, exactly the same braking force is not produced because the brake pedal is pressed down by a human foot, and consequently values of peak to peak are not always the same, becoming as shown in Table 1 as reference values. If a maximum torque of the vehicle is raised, the pitch rate can be further controlled.

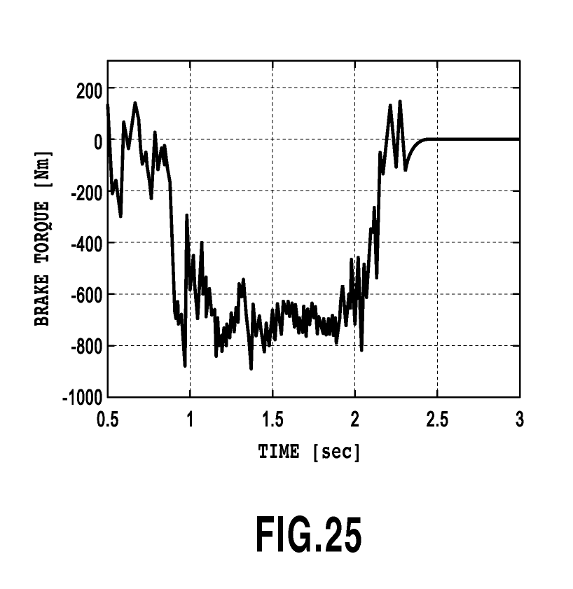

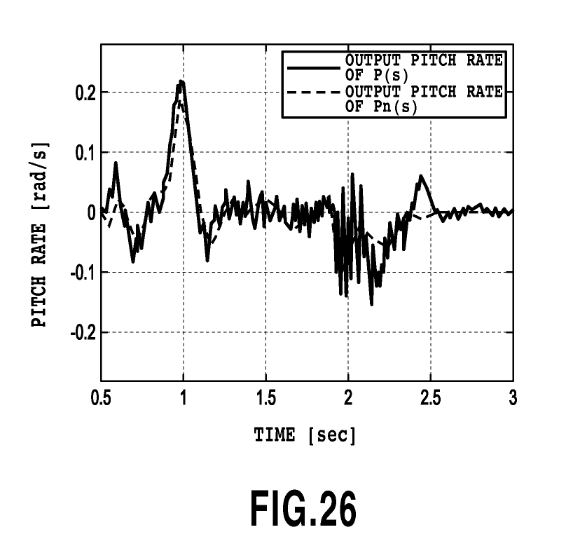

Next, FIG. 25 shows the brake torque estimated value in the case of considering the slip ratio. Moreover, FIG. 26 shows the output pitch rates of the actual plant P(s) and the nominal plant Pₙ(s). Waveforms of the output pitch rates of the actual plant P(s) and the nominal plant Pₙ(s) coincide with each other at a time point when the control is not imposed. This indicates that the brake torque estimated value is an appropriate value.

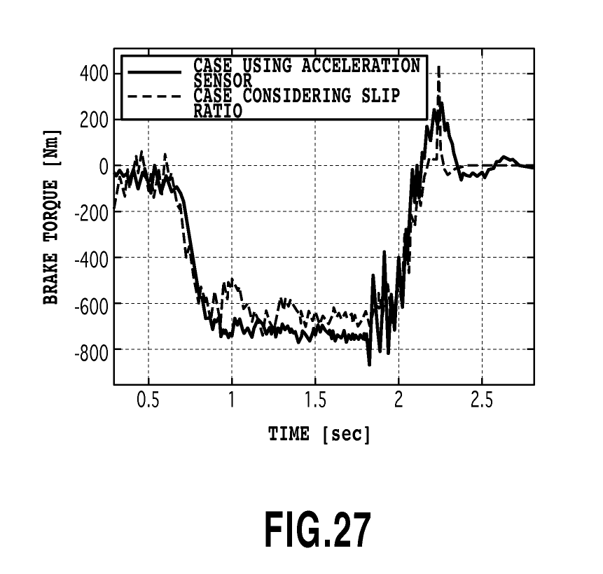

FIG. 27 shows the brake torque estimated value using the acceleration sensor and the brake torque estimated value in the case of considering the slip ratio. Although the brake torque estimated value using the acceleration sensor exhibits some shift to the brake torque estimated value considering the slip ratio, the use of the acceleration sensor enables simple estimation of the brake torque.

### 14. Case Considering Time Variation Dot of Slip Ratio

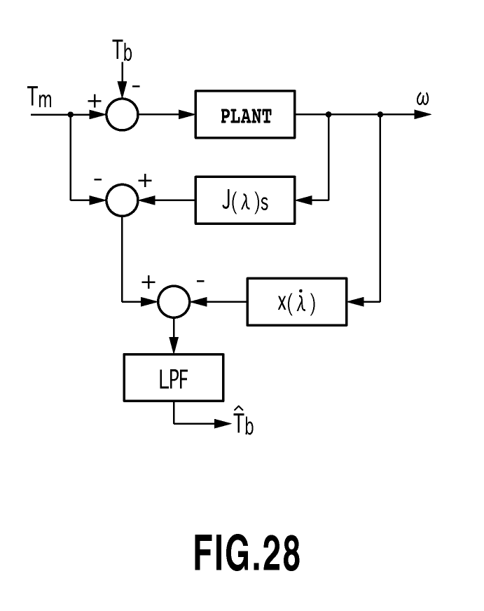

Until the preceding chapter, in a method for estimating the brake torque considering the slip ratio, the estimation was performed assuming that a time variation of the slip ratio λdot was sufficiently small and setting λdot as λdot=0, estimation considering a term of a variation of the slip ratio λdot is thought. FIG. 28 shows a block diagram for performing the brake torque estimation considering the variation of the slip ratio λdot. In FIG. 28, when V>V_{ω} holds, J(λ) becomes (λ)=J_{brake}(λ) and

$$\begin{matrix}[ Formula 34 ] & \\ X ( \dot{λ} ) = \frac{{r}^{2} m ω \dot{λ}}{{( 1 + λ )}^{2}} & \end{matrix}$$

and when V_{ω}>V holds, J(λ) becomes J(λ)=J_{acc}(λ) and

[Formula 35]

X(\dot{λ})=r²mω\dot{λ}

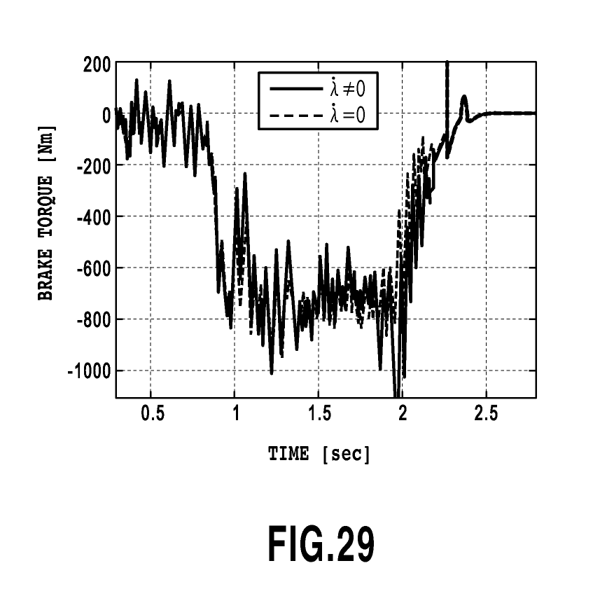

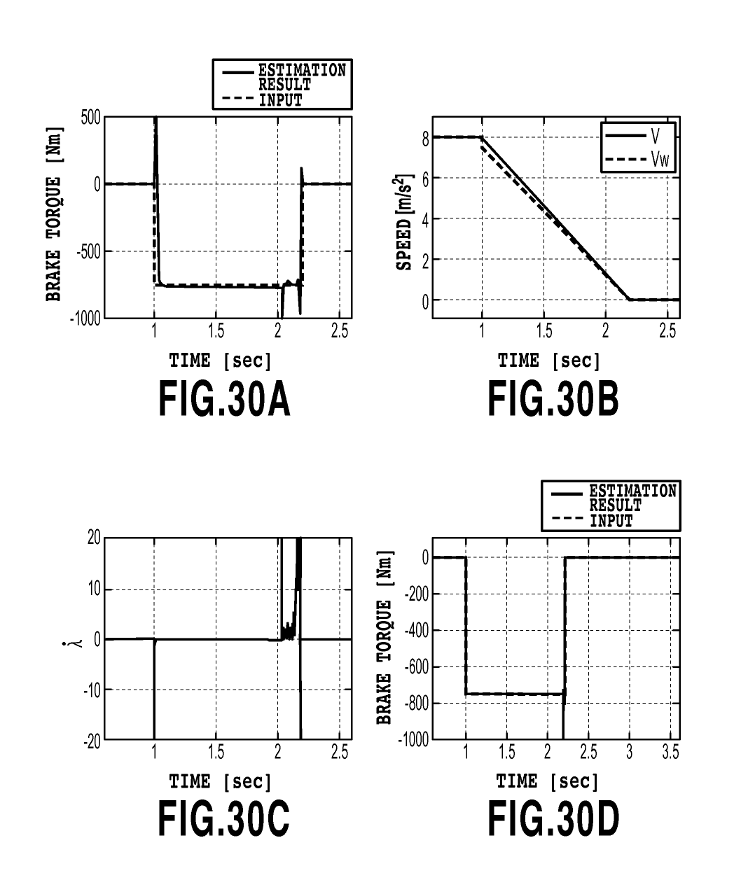

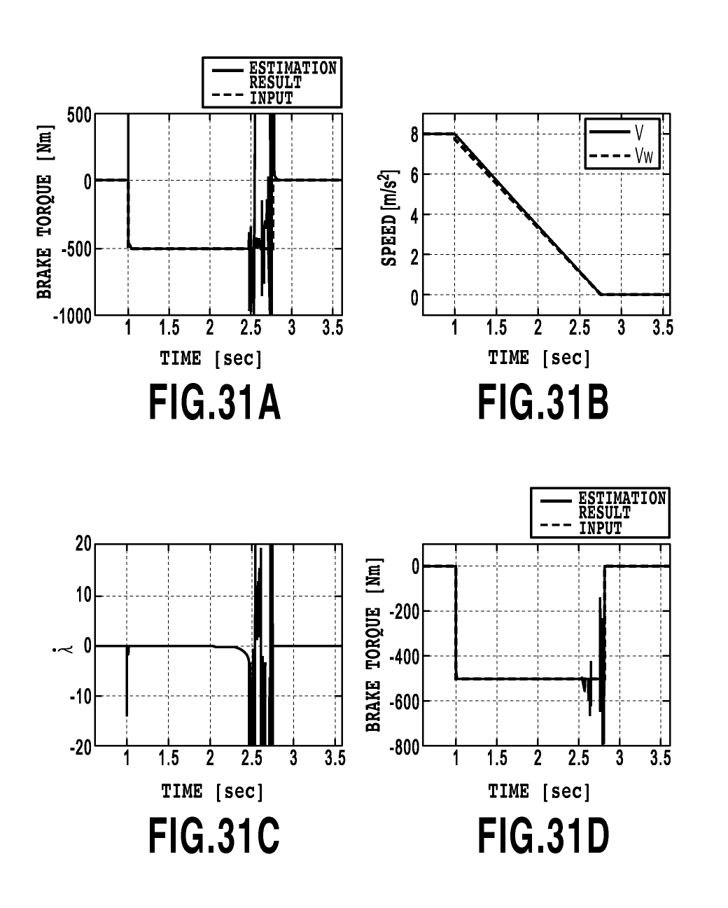

FIG. 29 shows experimental results in the case where estimation is performed assuming λdot≠0 where the slip ratio varies temporally and in the case where estimation is performed assuming λdot=where the slip ratio is constant. The experimental environment is the same as the preceding chapter. However, since FIG. 29 could not show a difference clearly, verification by a simulation was performed. Simulation conditions are the same as those of Chapter 12. FIG. 30A to FIG. 30D and FIG. 31A to FIG. 31D show simulation results at the time of giving brake torques of 750 Nm and 500 Nm on the high μ road, respectively. FIG. 30A and FIG. 31A show the brake torque estimated value in the case of considering λdot; FIG. 308 and FIG. 31B show the wheel speed and the car body speed at the time of FIG. 31A; FIG. 30C and FIG. 31C show the λdot at the time of FIG. 30A and FIG. 31A; and FIG. 30D and FIG. 31D show the brake torque estimated value in the case where λdot=0 holds and the slip ratio is assumed to be constant.

FIG. 30A to FIG. 30D indicate that when the estimation is performed considering the time variation of the slip ratio λdot, the brake torque estimated value behaves violently compared with the case where the slip ratio is constant and the estimation is performed by approximating the slip ratio with λdot=0. This is thought to be an influence of the time variation of the slip ratio λdot of FIG. 30B. Moreover, FIG. 31A to FIG. 31D show that in the case where the brake torque of the input is lowered to 500 Nm, a waveform of the estimated value has disordered by an influence of the time variation of the slip ratio λdot.

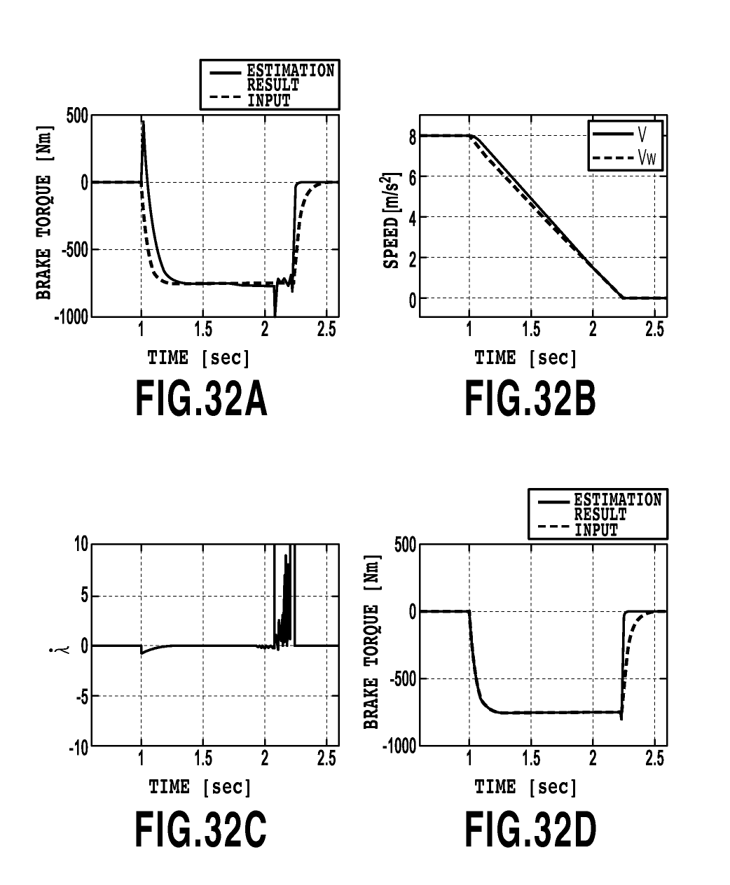

Next, FIG. 32A to FIG. 32D show simulation results in the case where a brake torque of 750 Nm that produces a mild rise and a mild fall on the high μ road. Like FIG. 30A to 30D and FIG. 31A to 31D, FIG. 32A shows the brake torque estimated value considering λdot, FIG. 32B shows the wheel speed and the car body speed at the time of FIG. 32A, FIG. 32C shows the time variation of the slip ratio λdot at the time of FIG. 32A, and FIG. 32D shows the brake torque estimated value in the case where the slip ratio is constant and λdot=0 is assumed. Since it is thought that the brake torque is associated with an amount of human pressing on the brake pedal and it is not given in a step form strictly, a simulation is conducted giving one obtained by making the brake torque in a step form pass through a low pass filer as an input. Cutoff of the low pass filter was set to 20 rad/s.

Since the time variation of the slip ratio λdot of FIG. 32C has become small compared with the case where the brake torque is not made to pass through the low pass filter, thereby the brake torque estimated value of FIG. 32 is somewhat improved. A reason that the estimated value reaches zero earlier than the input value does at around t=2.25 sec is that the vehicle has already stopped at that time.

### Third Embodiment

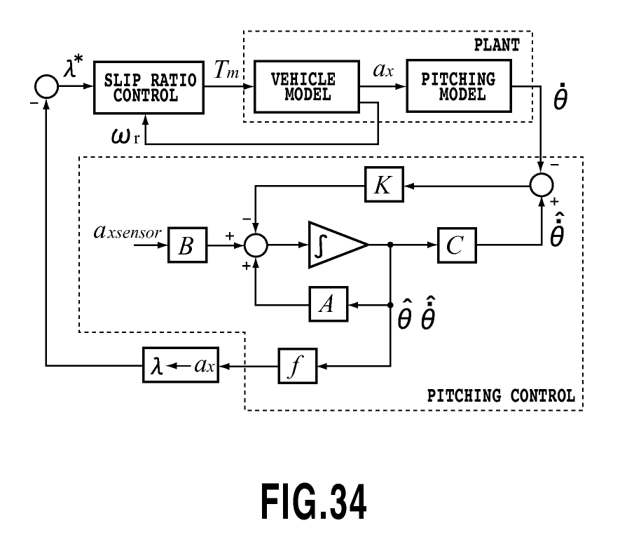

FIG. 34 shows a block diagram showing the whole control system of the pitching control device according to a third embodiment of the present invention. In the third embodiment, by separating a slip ratio control system and a pitching control system, a motion of wheels and a motion of pitching are controlled separately. By doing this, it becomes unnecessary to use the wheel angular velocity ω and the wheel angular acceleration ωdot that are used in the second embodiment and on which a large noise tends to ride easily.

The pitching control system, similarly with the first and second embodiments, estimates state variables including the pitch angle through the state observer using a model of computing a pitch angle θ from the moment M about the point of the center of gravity of the motor vehicle based on variations of the loads of the wheels considering the anti-dive force and the anti-lift force, and performs a state feedback control using the estimated values of the state variables. The observer vector K and the feedback vector f are designed using the pole assignment technique.

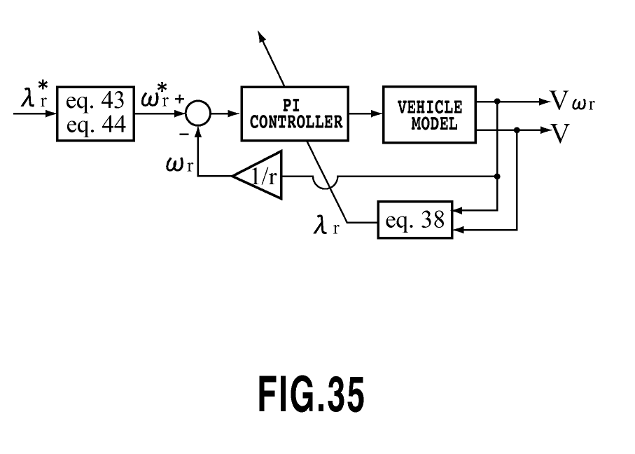

Moreover, the slip ratio control system uses a slip ratio control based on a wheel speed control, and generates an ideal motor torque Tₘ based on the slip ratio λ derived from the car body acceleration aₓ generated by the pitching control system and the wheel speed ω derived from the car body speed V. FIG. 35 shows a block diagram of the wheel speed control system of the pitching control device according to the third embodiment of the present invention. Although a control gain of the PI controller is determined regarding the moments of inertia of the wheels, it is configured so that the control gain is subjected to on-line tuning so that the pole is kept constant depending on the variation of the slip ratio.

The third embodiment will be also explained in detail below, like the second embodiment, based on the contents of Chapters 1 to 4, together with results of a simulation and an experiment conducted using a model that was identified in Chapter 9.

### 15. Vehicle Model

Equations of motions of the front and rear wheels about the respective rotating shafts become as follows.

[Formula 36]

J_{ωf}\dot{ω}_{f}=−rF_{f}−T_{b:} (33)

[Formula 37]

J_{ωr}\dot{ω}ᵣ=Tₘ−rFᵣ−T_{b:} (34)

The mechanical brake generally works on four wheels. In this embodiment, it is assumed that brake torques T_{b}'s of the four wheels are equal for simplification,

Moreover, an equation of motion of the car body becomes as follows.

[Formula 38]

mV=F_{d} (35)

However, F_{d} becomes F_{d}=2F_{f}+2Fᵣ. Moreover, the running resistance shall be ignored. Moreover, the slip ratio is expressed by Formula (27).

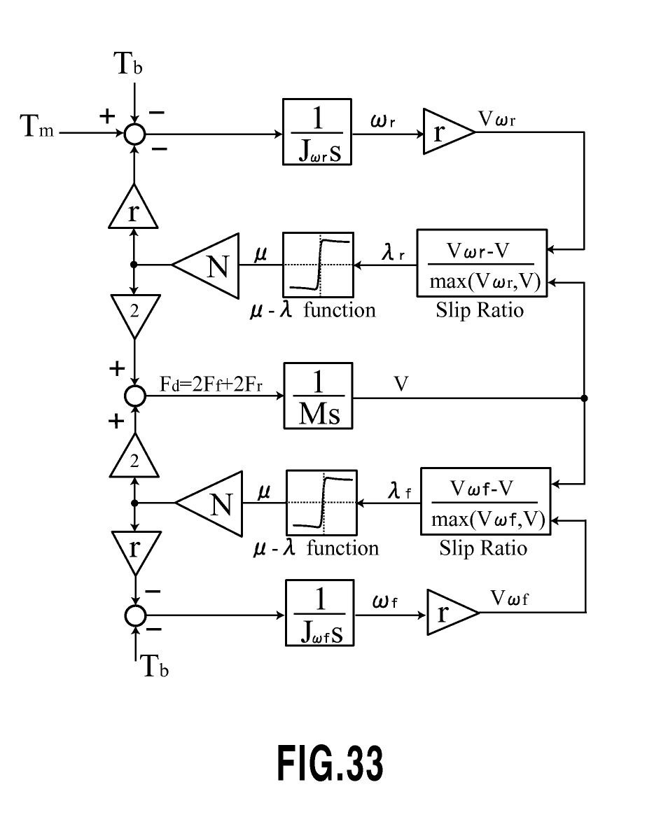

FIG. 33 shows a block diagram of a vehicle model that summarizes these formulae, i.e., a vehicle model that is used in the pitching control device according to the third embodiment of the present invention. Variables are: rotation angle velocities ωᵣ, ω_{f}[rad/s] of the motor; the car body speed V[m/s]; the wheel speeds V_{ωr}, V_{ωf}[m/s]; the motor torque Tₘ of the driving wheels[nm]; the brake torque T_{b}[nm]; the driving force F_{d} of the vehicle[N]; and the driving forces of the front wheels and the rear wheels Fᵣ, F_{f}[N]. Constants shall be: the car body weight m[kg], the tire radius r[m], and the moments of inertia of the wheel rotation parts of the front wheels and the rear wheels J_{ωr}, J_{ωf}[Nms²].

In the third embodiment, Magic Formula was adopted as a g-λ curve showing a relation of a friction coefficient between a tire and the road surface and the slip ratio.

### 16. Control System Design

In the second embodiment, when obtaining the brake torque and the nominal acceleration, the wheel angular acceleration ωdot was used. However, due to an influence of the low resolution of the hall sensor of the motor, a large noise rides on the wheel angular acceleration obtained by differentiating the rotation angular velocity of the motor. Thereupon, in the third embodiment, by incorporating the slip ratio control system (refer to Nonpatent Document 8) based on the wheel speed control into an inner loop of the pitching control system, the pitching motion and the motion of the wheels are respectively separately controlled. Thereby, it is possible to perform a high-accuracy control considering the road surface state without using ωdot.

Moreover, although in the first and second embodiments, the pitching control systems of a feedforward base have been proposed, in the third embodiment, the state feedback control that uses the observer is used as the pitching control system. Thereby, it becomes stronger also to the influence of the modeling error, etc.

FIG. 34 shows a block diagram showing the whole control system of the pitching control device according to the third embodiment of the present invention. Since the control input obtained from the pitching control system is an acceleration command, it is necessary to convert it into one in a dimension of the slip ratio that becomes a command value of the slip ratio control system. A formula that expresses a relation of the slip ratio and the driving force is shown below.

[Formula 39]

Fᵢ=Dₛλᵢ (36)

Ds denotes driving stiffness, λi represents the slip ratios of the front wheels and the rear wheels λᵣ, λ_{f}, and Fᵢ represents the driving forces Fᵣ, F_{f}. The command value of a rear wheel slip ratio can be found from this Formula (36) and Formula (35) as follows. Below, the pitching control system and the slip ratio control system that were used in the third embodiment will be explained.

$$\begin{matrix}[ Formula 40 ] & \\ {λ}_{r}^{*} = \frac{{ma}_{x}}{2 {D}_{s}} - {λ}_{f} & ( 37 )\end{matrix}$$

From Formula (37), the rear wheel slip ratio that becomes the command value of the slip ratio control system can be found.

<16-1> Pitching Control by State Feedback

The control object is expressed as follows from Formula (17).

[Formula 41]

x=Ax+Bu (38)

[Formula 42]

y=Cx (39)

$$\begin{matrix}[ Formula 43 ] & \\ A = [ \begin{matrix}0 & 1 \\ - K / I & - C / I\end{matrix} ] , \\ B = [ \begin{matrix}0 \\ Q / I\end{matrix} ] \\ C = [ \begin{matrix}0 & 1\end{matrix} ] , \\ x = [ \begin{matrix}θ \\ \dot{θ}\end{matrix} ] , \\ u = {a}_{x} & \end{matrix}$$

Since the above-mentioned system is observable,

[Formula 44]

A−KC

it can be said that a matrix K exists that defines a characteristic value of A−KC to an arbitrary value. Thereupon, the same dimension observer was designed. An observer gain vector found by the pole assignment becomes as follows. However, r₁ and r₂ are the poles of the observer.

$$\begin{matrix}[ Formula 45 ] & \\ K = [ \begin{matrix}- \frac{Kn}{In} ( {r}_{1} {r}_{2} - \frac{Kn}{In} ) \\ - ( {r}_{1} + {r}_{2} - \frac{Cn}{In} )\end{matrix} ] & ( 40 )\end{matrix}$$

The state feedback control is performed using the state variables estimated by the observer shown above. A feedback matrix is found by the pole assignment like the observer. The found feedback matrix becomes as follows. However, w₁ and w₂ are the poles of a regulator.

$$\begin{matrix}[ Formula 46 ] & \\ f = [ \frac{In}{Q} ( {w}_{1} {w}_{2} - \frac{Kn}{In} ) \frac{In}{Q} ( - {w}_{1} - {w}_{2} - \frac{Cn}{In} ) ] & ( 41 )\end{matrix}$$

<16-2> Slip Ratio Control Based on Wheel Speed Control

The target wheel speed can be computed from the target slip ratio λ* obtained from the pitching control system and the car body speed. Although it is assumed that the car body speed is detectable from the sensor in this paper, the car body speed may be found by estimating the slip ratio (refer to Nonpatent Documents 8, 10). At this time, since it may be also thought that the wheel speed becomes larger than the car body speed, the case is divided into two cases: a case where the car body speed is larger (Formula (42)); and a case where the wheel speed is larger (Formula (43)).

$$\begin{matrix}[ Formula 47 ] & \\ {ω}_{r} = \frac{V ( 1 + λ )}{r} : V > {V}_{ω} & ( 42 ) \\ [ Formula 48 ] & \\ {ω}_{r} = \frac{V}{r ( 1 - λ )} : {V}_{ω} > V & ( 43 )\end{matrix}$$

By this, the slip ratio control is realized by using a rotation speed control including a speed loop outside a current control loop of the motor generally used.

FIG. 35 shows a block diagram showing the wheel speed control of the pitching control device according to the third embodiment of the present invention. Generally, the speed controller determines a control gain by the pole assignment technique using a PI controller based on the following formula considering only the moment of inertia of the wheel.

$$\begin{matrix}[ Formula 49 ] & \\ ω = \frac{1}{{J}_{ω r} s} T & ( 44 )\end{matrix}$$

However, since the moment of inertia of the entire car body varies depending on the fluctuation of the slip ratio, if the controller is designed only by the moments of inertia of the wheels, the pole of the controller will vary depending on a variation of the slip ratio. Thereupon, it is necessary to make a control gain variable so that the pole may be kept constant.

Summarizing Formulae (27), (33), and (35) for respective cases V>V_{ω} and V_{ω}>V, these will become as follows.

$$\begin{matrix}[ Formula 50 ) & \\ \begin{matrix}{ω}_{r} = \frac{{T}_{m} - 2 {T}_{b} + \frac{{r}^{2} m {ω}_{r} \dot{λ}}{2 {( 1 + λ )}^{2}} - {J}_{{ω}_{f}} {\dot{ω}}_{f}}{( {J}_{ω r} + \frac{{r}^{2} m}{2 ( 1 + λ )} ) s} \\ = \frac{{T}_{m} - 2 {T}_{b} + \frac{{r}^{2} m {ω}_{r} \dot{λ}}{2 {( 1 + λ )}^{2}} - {J}_{{ω}_{f}} {\dot{ω}}_{f}}{{J}_{brake } ( λ ) s} \text{:} V > {V}_{ω}\end{matrix} & ( 45 )\end{matrix}$$

$$\begin{matrix}[ Formula 51 ) & \\ \begin{matrix}{ω}_{r} = \frac{{T}_{m} - 2 {T}_{b} + \frac{1}{2} {r}^{2} m {ω}_{r} \dot{λ} - {J}_{{ω}_{f}} {\dot{ω}}_{f}}{( {J}_{ω r} + \frac{1}{2} {r}^{2} m ( 1 - λ ) ) s} \\ = \frac{{T}_{m} - 2 {T}_{b} + \frac{1}{2} {r}^{2} m {ω}_{r} \dot{λ} - {J}_{{ω}_{f}} {\dot{ω}}_{f}}{{J}_{accel } ( λ ) s} \text{:} {V}_{ω} > V\end{matrix} & ( 46 )\end{matrix}$$

Formula (45) expresses the case where V>V_{ω} holds and Formula (46) expresses the case where V_{ω}>V holds. The control gain is tuned on-line so that the poles may become constant for these two formulae of J_{brake}(λ) and J_{accel}(λ).

### 17. Simulation

The simulation was conducted using the above-mentioned vehicle model of Chapter 15 and the control system of Chapter 16. The simulation shall observe the vehicle running on the high μ road way (peak μ=0.9) while a brake torque of 150 Nm is given to the wheels until the vehicle stops. Since there was a problem in the first embodiment that when the pitching control is always worked, a braking distance will elongates, the slip ratio control system shall be operated always while the command value shall be set to λᵣ=−0.04, and when the car body speed becomes 1.5 m/s or less, it shall be switched to the command value of the slip ratio obtained from the pitching control system. Moreover, the parameters were set as: J_{ωr}=1.0 Nms², J_{ωf}=0.5 Nms², r=0.22 m, and m=480 kg, and driving stiffness was set to a fixed value, Dₛ=15000.

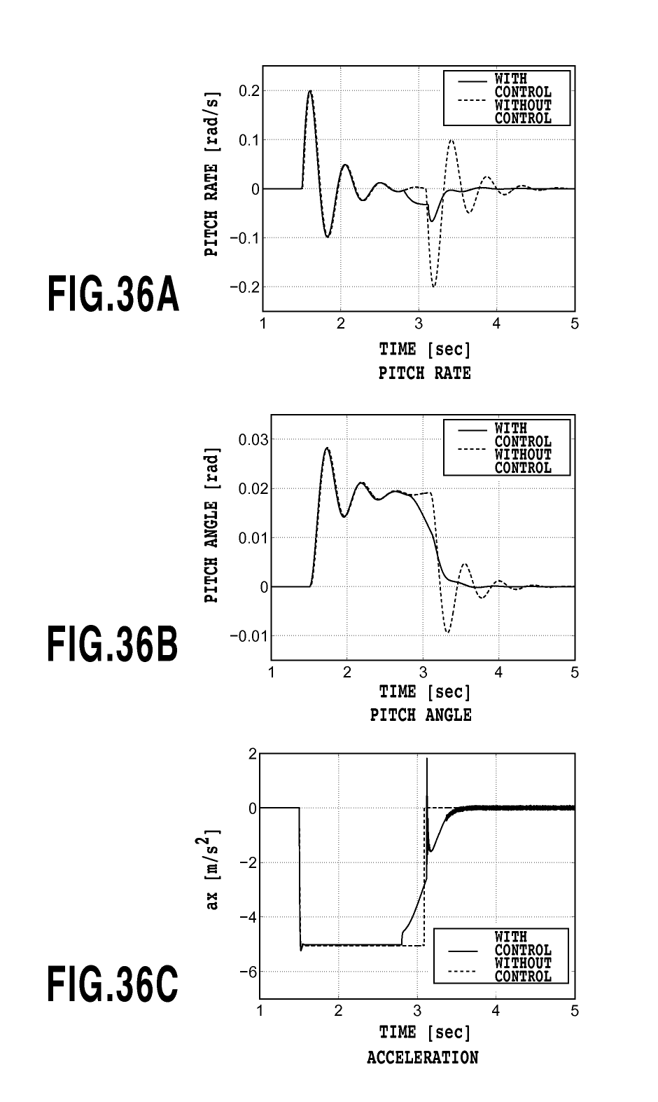

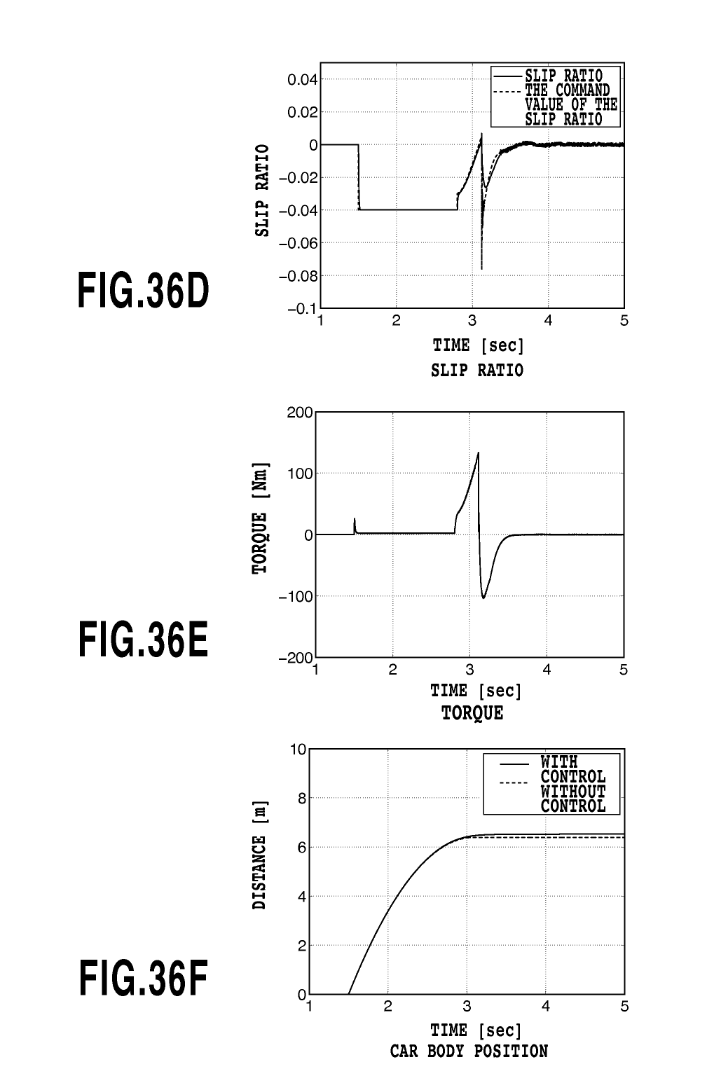

First, FIG. 36A to FIG. 36F show simulation results when assuming that the control object P(s) is equivalent to the identified model Pₙ(s). At this time, the pole of the regulator was set to −3 rad/s, the pole of the observer was set to −10 rad/s, and the pole of the slip ratio control was set to −120 rad/s. FIG. 36A shows a pitch rate, FIG. 36B shows a pitch angle, FIG. 36C shows an acceleration, FIG. 36D shows a slip ratio, FIG. 36E shows an actual torque, and FIG. 36F shows a distance after starting of braking until the vehicle stops.

As shown in FIG. 36A and FIG. 36B, the pitch rate and the pitch angle are controlled, respectively, compared with the case without the control. Moreover, as shown in FIG. 36D, the slip ratio is following the command value although there is a little error between them. Furthermore, as shown in FIG. 36F, even when the control is imposed, the distance until the vehicle stops hardly variations compared with the case without the control. This is thought important when it is mounted on the motor vehicle actually.

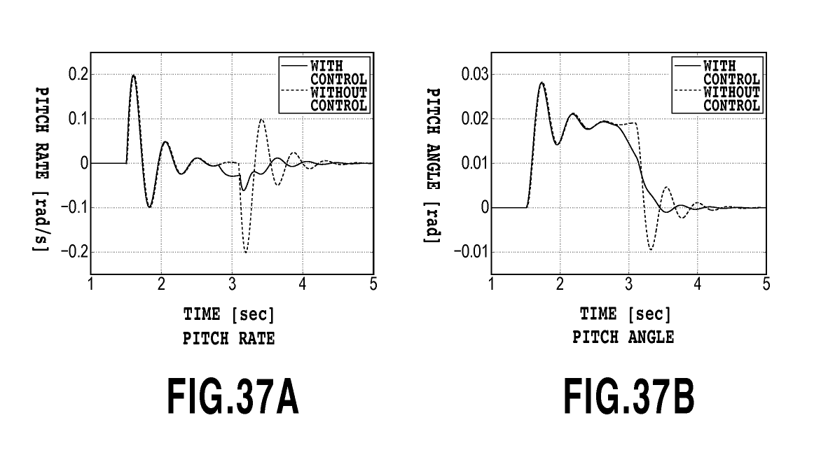

Next, FIG. 37A and FIG. 37B show the pitch rates and the pitch angles in the case of the model P(s) where a resonance frequency of the control object P(s) is identified and in the case where a control is performed after giving a modeling error of 5%, and in the case without the control. Simulation conditions are exactly the same as those of the cases of FIG. 36A to FIG. 36F. As shown by this result, although in the third embodiment, some vibration remains in the case where there is a large modeling error, both the pitch angle and the pitch rate can be controlled compared with the case without the control.

### 18. Experiment

An experiment was conducted using a control method hitherto shown. The experiment shall observe the vehicle until the vehicle stops by a mechanical brake during running at about 27 km/h on the high μ road (dry road). At this time, like the simulation, the slip ratio control system is always made to work while the command value is set to λᵣ=−0.06, and from when the car body speed becomes 1.5 m/s or less, the pitching control is started. Moreover, the parameters were set as: J_{ωr}=1.0 Nms², r=0.22 m, and m=480 kg, and the driving stiffness Ds was set to 15000, a constant value. Furthermore, the setup shall be as follows: the pole of the discretized observer is −0.7 rad/s, the pole of the regulator is −6 rad/s. The pole of slip ratio control shall be −70 rad/s, but from a problem that the slip ratio becomes vibrational in a low speed domain, it shall be switched to −50 rad/s from the time of starting of the pitching control.

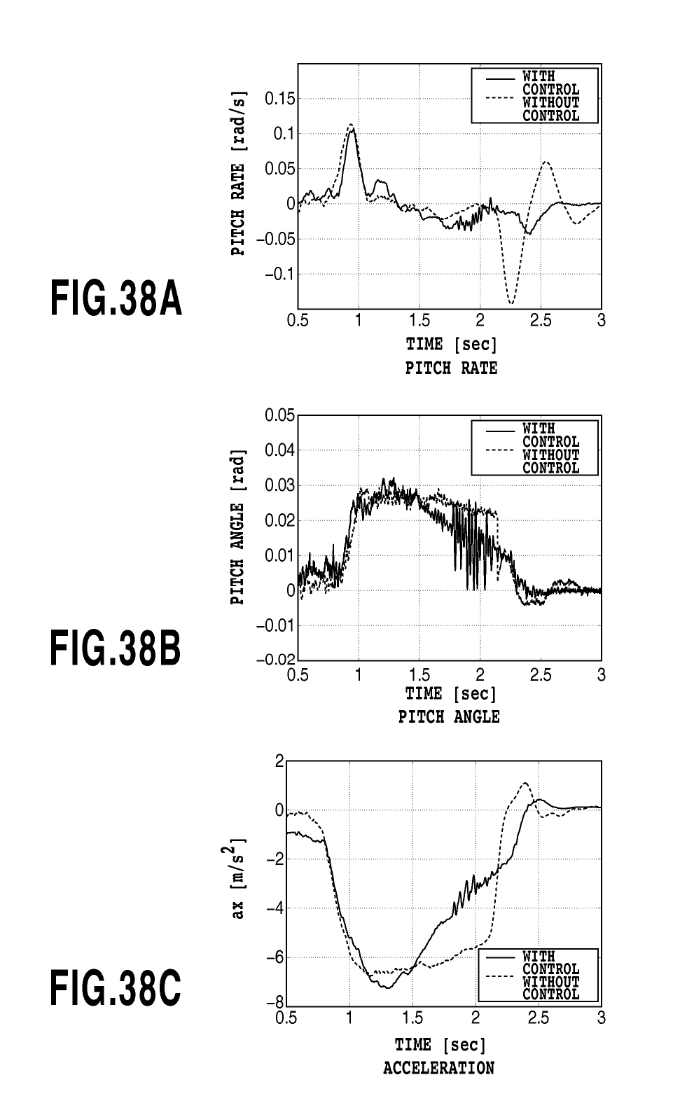

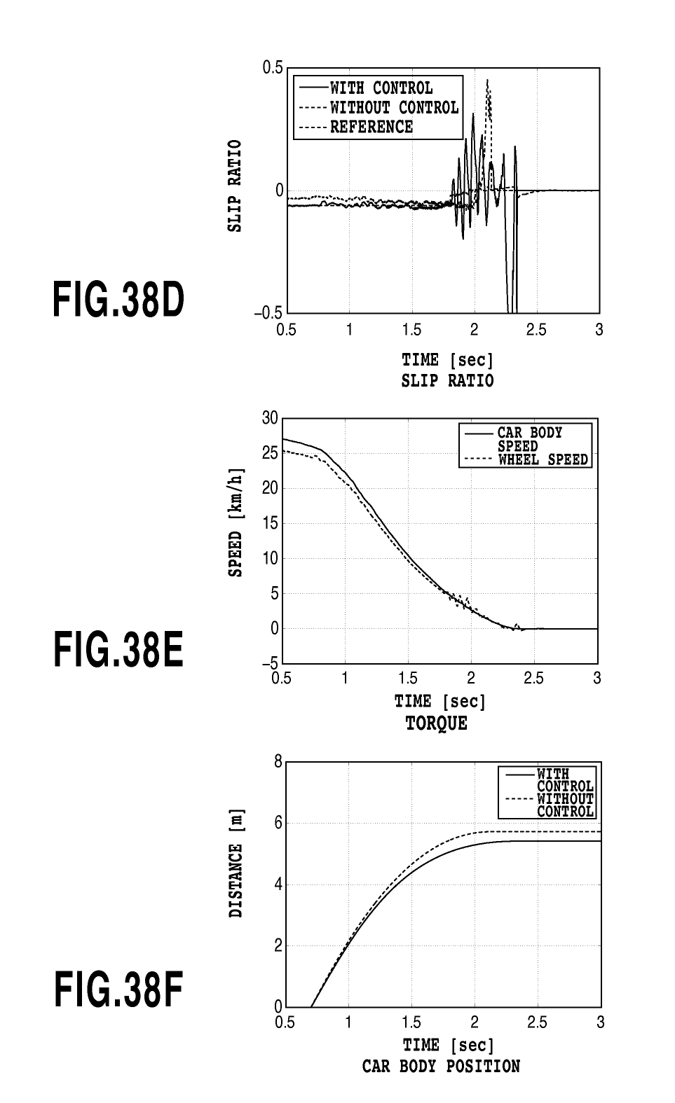

FIG. 38A to FIG. 38F show the experimental results of the pitching control device according to the third embodiment of the present invention. FIG. 38A and FIG. 38B show the measured pitch rate and the estimated pitch angle, respectively, in each of which the case with the control and the case without the control are compared. Thus, the pitch rate and the pitch angle are controlled like the simulation. FIG. 38C compares accelerations at that time in the case with the control and in the case without the control. FIG. 38D expresses the slip ratios at that time, and compares the command value, the case with the control, and the case without control. In the case with the control, it follows the command value completely until when the pitching control is started. FIG. 38E shows the wheel speed and the car body speed at that time. Furthermore, FIG. 38F shows the distances after the starting until the vehicle stops in the case with the control and in the case without the control, respectively. This was found by integrating the car body speed. This diagram indicates that in the case with the control a distance until the vehicle stops is short compared with the case without the control. Although it is thought that this may change depending on the command value of the slip ratio, it is thought that the distance until the vehicle stops hardly elongates.

In the third embodiment, it is possible to perform the pitching control that considers the road surface state more strictly than the first and second embodiments by incorporating the slip ratio control system using the wheel speed control into an inner loop of the pitching control system. Furthermore, it was also shown from an experimental result that it is possible to install it.

1. A pitching control device, in a vehicle that drives its driving wheels with a torque of a motor,
comprising:
pitch angle computing means for computing a pitch angle of the motor vehicle from a moment about the center of gravity of the motor vehicle based on loads applied to wheels of the motor vehicle at the time of standstill, loads applied to the wheels of the motor vehicle at the time of acceleration and deceleration by the motor, and variations of loads applied to the wheels of the motor vehicle by an anti-dive force working on front wheels of the motor vehicle and an anti-lift force working on rear wheels of the motor vehicle at the time of braking by a brake;
motor torque computing means for computing a motor torque of the motor based on the pitch angle; and
motor control means for controlling the motor using the motor torque.

2. The pitching control device according to claim 1,
further comprising feedback means for compensating a difference between a pitch rate derived from the pitch angle computed by the pitch angle computing means and a pitch rate of the motor vehicle.

3. The pitching control device according to claim 1,
wherein
the pitch angle computing means performs computation based on Formula (A),
$$\begin{matrix}[ Formula 1 ] & \\ θ = \frac{- 2 mh - m ( β {l}_{f} tan {φ}_{f} + ( 1 - β ) {l}_{r} tan {φ}_{r} )}{{Is}^{2} + Cs + K} {a}_{x} , & ( A )\end{matrix}$$
(where m: car body weight,
h: distance from the plane ground to the center of gravity,
l_{f}: distance between the center of gravity and a front wheel shaft,
lᵣ: distance between the center of gravity and a rear wheel shaft,
I: moment of inertia about a y-axis of the car body,
C: damper coefficient,
K: spring constant,
β: braking force distributed to the front wheels,
φ_{f}: anti-dive force direction, and φᵣ: anti-lift force direction).

4. The pitching control device according to claim 1, further comprising brake torque estimating means for estimating a brake torque, wherein
the pitch angle computing means computes an acceleration based on the brake torque.

5. The pitching control device according to claim 4,
wherein
the brake torque estimating means performs estimation considering a slip ratio.

6. The pitching control device according to claim 5,
wherein
the brake torque estimating means performs estimation considering a time variation of the slip ratio.

7. The pitching control device according to claim 4,
further comprising an acceleration sensor for measuring the acceleration of a car body of the motor vehicle,
wherein
the brake torque estimating means performs estimation using the acceleration.

8. A pitching control device, in a vehicle that drives its driving wheels by a torque of a motor,
comprising:
in a vehicle that drives its driving wheels by a torque of the motor,
an acceleration sensor for measuring an acceleration of a car body of the motor vehicle;
state feedback control means that estimates state variables including a pitch angle through a state observer using a model for computing the pitch angle from a moment about a point of the center of gravity of the motor vehicle based on the acceleration, loads applied to wheels of the motor vehicle at the time of standstill, loads applied to the wheels of the motor vehicle at the time of acceleration and deceleration, variations of loads applied to the wheels of the motor vehicle by an anti-dive force working on front wheels of the motor vehicle and an anti-lift force working on rear wheels of the motor vehicle at the time of braking by a brake, and uses estimated values of the state variables;
wheel speed control means for computing a motor torque of the motor based on a slip rate that was computed by the state feedback control means; and
motor control means for controlling the motor using the motor torque.

9. The pitching control device according to claim 8,
wherein
the wheel speed control means determines a control gain by a pole assignment technique considering only moments of inertia of the wheels, and the control gain is adjusted so that the pole may become constant to the moments of the inertia of the wheels at the time of acceleration and deceleration.

10. The pitching control device according to claim 8, wherein
the pitch computing means for computing the pitch angle based on a formula (A)
$$\begin{matrix}[ Formula 2 ] & \\ θ = \frac{- 2 mh - m ( β {l}_{f} tan {φ}_{f} + ( 1 - β ) {l}_{r} tan {φ}_{r} )}{{Is}^{2} + Cs + K} {a}_{x} , & ( A )\end{matrix}$$
(where m: car body weight,
h: height from the ground plane to the center of gravity,
l_{f}: distance between the center of gravity and a front wheel shaft,
lᵣ: distance between the center of gravity and a rear wheel shaft,
I: moment of inertia about a y-axis of the car body,
C: damper coefficient,
K: spring constant,
β: braking force distributed to the front wheel,
φ_{f}: anti-dive force direction, and
φᵣ: anti-lift force direction).

11. A pitching control method, in a vehicle that drives its driving wheels by a torque of a motor,
comprising:
a pitch angle computation step of computing a pitch angle of the driving wheels from a moment about a point of the center of gravity of the motor vehicle based on loads applied to wheels of the motor vehicle at the time of standstill, load imposed on the wheels of the motor vehicle at the time of acceleration and deceleration by the motor, and variations of loads applied to the wheels of the motor vehicle by an anti-dive force working on front wheels of the motor vehicle and an anti-lift force working on rear wheels of the motor vehicle at the time of braking by a brake;
a motor torque computation step of computing a motor torque of the motor based on the pitch angle; and
a motor control step of controlling the motor using the motor torque.

12. The pitching control method according to claim 11,
further comprising a feedback control step of compensating a difference between a pitch rate derived from a pitch angle computed at the pitch angle computation step and a pitch rate of the motor.

13. The pitching control method according to claim 11,
wherein
the pitch angle computation step computes the pitch angle based on Formula (A),
$$\begin{matrix}[ Formula 3 ] & \\ θ = \frac{- 2 mh - m ( β {l}_{f} tan {φ}_{f} + ( 1 - β ) {l}_{r} tan {φ}_{r} )}{{Is}^{2} + Cs + K} {a}_{x} , & ( A )\end{matrix}$$
(where m: car body weight,
h: height from the ground plane to the center of gravity,
l_{f}: distance between the center of gravity and a front wheel shaft,
lᵣ: distance between the center of gravity and a rear wheel shaft,
I: moment of inertia about a y-axis of the car body,
C: damper coefficient,
K: spring constant,
β: braking force distributed to the front wheel,
φ_{f}: anti-dive force direction, and
φᵣ: anti-lift force direction).

14. The pitching control method according to claim 11,
further comprising a brake torque estimation step of estimating the brake torque,
wherein
the pitch angle computing means computes the acceleration based on the brake torque.

15. The pitching control method according to claim 14,
wherein
the brake torque estimation step performs estimation considering a slip ratio.

16. The pitching control method according to claim 15,
wherein
the brake torque estimation step performs estimation further considering a time variation of the slip ratio.

17. The pitching control method according to claim 14,
further comprising an acceleration measurement step of measuring an acceleration of a car body of the motor vehicle with an acceleration sensor,
wherein the brake torque estimation step performs estimation using the acceleration.

18. A pitching control method, in a vehicle that drives its driving wheels by a torque of a motor,
comprising:
an acceleration measurement step of measuring acceleration of a car body of a vehicle by an acceleration sensor;
a state feedback control step of estimating state variables including a pitch angle through a state observer using a model of computing a pitch angle from a moment about the center of gravity of the motor vehicle based on variations of loads applied to wheels of the motor vehicle by the acceleration, loads applied to the wheels of the motor vehicle at the time of standstill, loads applied to the wheels of the motor vehicle at the time of acceleration and deceleration by the motor, and an anti-dive force working on the front wheels of the motor vehicle and an anti-lift force working on the rear wheels of the motor vehicle at the time of braking by a brake, and using the estimated values of the state variables;
a wheel speed control step of computing a motor torque of the motor based on a slip ratio computed by the state feedback control means; and
a motor control step of controlling the motor using the motor torque.

19. The pitching control method according to claim 18,
wherein
the wheel speed control step determines a control gain by a pole assignment technique considering only the moments of inertia of the wheels, and the control gain is adjusted so that the pole may become constant to the moments of inertia of the wheels at the time of acceleration and deceleration.

20. The pitching control method according to claim 18,
wherein
the pitch angle computation step computes the pitch angle based on Formula (A),
$$\begin{matrix}[ Formula 4 ] & \\ θ = \frac{- 2 mh - m ( β {l}_{f} tan {φ}_{f} + ( 1 - β ) {l}_{r} tan {φ}_{r} )}{{Is}^{2} + Cs + K} {a}_{x} & ( A )\end{matrix}$$
(where m: car body weight,
h: height from the ground plane to the center of gravity,
l_{f}: distance between the center of gravity and a front wheel shaft,
lᵣ: distance between the center of gravity and a rear wheel shaft,
I: moment of inertia about a y-axis of the car body,
C: damper coefficient,
K: spring constant,
β: braking force distributed to the front wheels,
φ_{f}: angle between the ground plane and an anti-dive force direction, and
φᵣ: angle between the ground plane and an anti-lift force direction).
